(19) United States
(12) Patent Application Publication
(10) Pub. No.: US 2016/0149716 A1
(43) Pub. Date: May 26, 2016

(54) Remote Management And Control Of Utility Appliances

(71) Applicant: Rajiv Nelson Raj, Mt. Laurel, NJ (US)

(72) Inventor: Rajiv Nelson Raj, Mt. Laurel, NJ (US)

(21) Appl. No.: 14/551,452

(22) Filed: Nov. 24, 2014

(51) Int. Cl. H04L 12/28; G05B 15/02

(52) U.S. Cl. CPC H04L 12/282; G05B 15/02

(57) ABSTRACT

A method and a system for remotely managing and controlling one or more utility appliances provide an appliance management system (AMS) accessible on a user device and operably communicating with an appliance control device via a local network. The appliance control device operably communicates with and controls the utility appliances via a load terminal relay unit and communicates an activation status of each utility appliance to the AMS via the local network. The appliance control device receives appliance control data for controlling one or more utility appliances based on the communicated activation status from the AMS via the local network. The appliance control device processes the received control data to generate a control data signal for indicating one or more actions to be performed by the utility appliances and transmits the generated control data signal to the load terminal relay unit for actuating the utility appliances to perform the actions.

### BACKGROUND

Rapid technology evolvement in recent years has witnessed a rise in the use of mobile applications aimed at making day to day activities of people less cumbersome. There is a need for a mobile application that communicates with home and other appliances via embedded devices for remotely managing and controlling the appliances from indoor and outdoor locations. For example, there is a need for a mobile application that allows a user to remotely switch on a thermostat at a predefined time, lock a security latch on a main door, turn a lamp on/off in a room, etc., to provide an efficient and convenient mode of living in a convenient environment.

Conventional methods and systems for managing and controlling home appliances typically allow control over the home appliances in a closed perimeter of a home, which is limited by the range of wireless connectivity that a home wireless network device provides. Therefore, these conventional methods and systems fail to facilitate remote access for controlling and managing the home appliances via a mobile application. Furthermore, these methods fail to establish a device handshake at different stages of communication of control signals from the mobile application to the home appliances. This results in a large amount of data being communicated over a network without ensuring connectivity of the devices to the network. This may result in network congestion therefore affecting the network speed of the home wireless network device.

Conventional home automation systems typically respond to commands sent from a remote control device, without reference to a current status of an appliance to be controlled. Updates on a current status of an appliance can allow a user to manage power utilization and reduce power consumption. Moreover, during a power outage, a typical automation system requires to be restarted resulting in a loss of automation commands sent to the automation system prior to the power outage, thereby rendering the automation process inconvenient and inefficient.

Hence, there is a long felt but unresolved need for a method and system that remotely manages and controls one or more utility appliances. Moreover, there is a need for a method and system that periodically performs network connectivity verification of devices involved in a communication between a user device and a utility appliance. Furthermore, there is a need for a method and system that controls utility appliances and dynamically retrieves and updates a status of each utility appliance to a user before and/or after automation, thereby allowing the user to efficiently manage power consumption by the utility appliances. Furthermore, there is a need for a computer implemented automation system that can dynamically resume an automation process after recovering from a power outage, thereby rendering the automation process convenient and time efficient.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method and system disclosed herein address the above stated need for remotely managing and controlling one or more utility appliances. Moreover, the method and system disclosed herein periodically performs network connectivity verification of devices involved in a communication between a user device and a utility appliance. Furthermore, the method and system disclosed herein controls utility appliances and dynamically retrieves and updates a status of each utility appliance to a user before and/or after automation, thereby allowing the user to efficiently manage power consumption by the utility appliances. Furthermore, the method and system disclosed herein can dynamically resume an automation process after recovering from a power outage, thereby rendering the automation process convenient and time efficient.

The method and system disclosed herein provides an appliance control device configured to operably communicate with an appliance management system accessible on a user device via a local network. The appliance control device operably communicates with and controls one or more of multiple utility appliances via a load terminal relay unit. The appliance management system acquires an activation status of each utility appliance from the appliance control device via the local network. The appliance control device communicates the activation status of each utility appliance to the appliance management system via the local network. The appliance management system receives user inputs to control one or more of the utility appliances based on the communicated activation status via a graphical user interface provided by the appliance management system. The appliance management system generates appliance control data for controlling the utility appliances based on the received user inputs. The appliance management system transmits the generated appliance control data to the appliance control device via the local network. The appliance control device receives the transmitted appliance control data from the appliance management system via the local network and processes the received appliance control data to generate a control data signal that indicates one or more actions to be performed by the utility appliances. The appliance control device transmits the generated control data signal to the load terminal relay unit for actuating the utility appliances to perform the actions.

In one or more embodiments, related systems include but are not limited to circuitry and/or programming for effecting the methods referenced herein; the circuitry and/or programming can be any combination of hardware, software, and/or firmware configured to effect the herein-referenced methods depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing carries over to the description of that method step or component shown by that same numeral in any subsequent drawing herein.

FIG. 1 illustrates a method for remotely managing and controlling one or more of multiple utility appliances using an appliance control device.

FIG. 2 illustrates a computer implemented method for remotely managing and controlling one or more of multiple utility appliances using an appliance management system.

FIG. 3 exemplarily illustrates a flowchart comprising the steps involved in managing and controlling a utility appliance.

FIG. 4 exemplarily illustrates a flow diagram comprising the steps involved in configuring one or more sensors and utility appliances in communication with an agent server.

FIG. 5 exemplarily illustrates a sequence diagram showing a flow of data between the appliance control device and a load terminal relay unit.

FIG. 6 exemplarily illustrates a sequence diagram showing flow of data between the appliance management system accessible on a user device and the appliance control device.

FIG. 7 exemplarily illustrates a work flow diagram showing communication between the appliance management system accessible on a user device and multiple utility appliances via the appliance control device over a local network.

FIG. 8 exemplarily illustrates a system for remotely managing and controlling one or more of multiple utility appliances.

FIG. 9 exemplarily illustrates an embodiment of the system for remotely managing and controlling a utility appliance.

FIG. 10 exemplarily illustrates software and hardware components of the system for remotely managing and controlling one or more of multiple utility appliances.

FIG. 11 exemplarily illustrates the architecture of a computer system employed by the appliance management system and an agent server for remotely managing and controlling one or more of multiple utility appliances.

FIG. 12 exemplarily illustrates a screenshot of a splash screen interface provided on a graphical user interface of the appliance management system.

FIG. 13 exemplarily illustrates a screenshot of a home page interface provided on the graphical user interface of the appliance management system.

FIG. 14 exemplarily illustrates a screenshot of a graphical user interface provided by the appliance management system on a user device, showing multiple menu options for remote management and control of utility appliances.

FIG. 15 exemplarily illustrates a screenshot of a search interface provided on the graphical user interface of the appliance management system.

FIG. 16 exemplarily illustrates a screenshot of a device addition interface provided on the graphical user interface of the appliance management system.

FIG. 17 exemplarily illustrates a screenshot of a device menu interface provided on the graphical user interface of the appliance management system.

FIG. 18 exemplarily illustrates a screenshot of a room addition interface provided on the graphical user interface of the appliance management system.

FIG. 19 exemplarily illustrates a screenshot of a room menu interface provided on the graphical user interface of the appliance management system.

FIG. 20 exemplarily illustrates a screenshot of a settings menu interface provided on the graphical user interface of the appliance management system.

FIG. 21 exemplarily illustrates a screenshot of a remote control list interface provided on the graphical user interface of the appliance management system.

FIG. 22 exemplarily illustrates a screenshot of a power control interface provided on the graphical user interface of the appliance management system.

FIG. 23 exemplarily illustrates a screenshot of the graphical user interface provided by the appliance management system on a user device for remotely managing and controlling lights.

FIGS. 24A-24B exemplarily illustrate screenshots of the graphical user interface provided by the appliance management system on a user device for remote activation and deactivation of lights.

FIG. 25 exemplarily illustrates a screenshot of the graphical user interface provided by the appliance management system for remotely managing and controlling an air conditioner.

FIG. 26 exemplarily illustrates a screenshot of the graphical user interface provided by the appliance management system on a user device for remotely managing and controlling an electronic door lock.

FIG. 27 exemplarily illustrates a screenshot of the graphical user interface provided by the appliance management system on a user device for remotely managing and controlling a television set via an infrared network.

FIG. 28 exemplarily illustrates a screenshot of a camera list interface provided on the graphical user interface of the appliance management system.

FIG. 29 exemplarily illustrates a screenshot of a video player interface provided on the graphical user interface of the appliance management system.

### DETAILED DESCRIPTION OF THE INVENTION

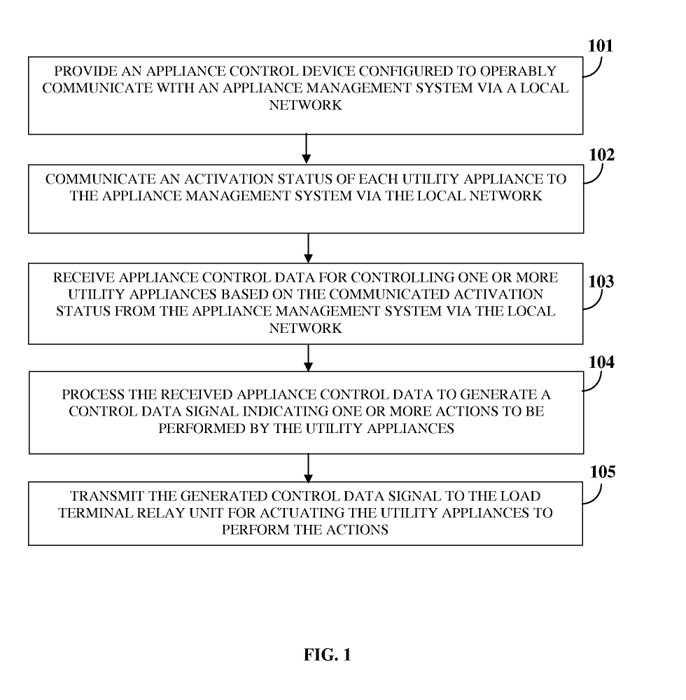

FIG. 1 illustrates a method for remotely managing and controlling one or more of multiple utility appliances using an appliance control device. As used herein, “utility appliances” refer to electrical and/or mechanical appliances that are used for utility and other purposes, for example, environmental purposes such as temperature control, providing utilities such as water supply, heating, etc., home use purposes, security purposes, media purposes, etc. The utility appliances are, for example, an air conditioner, an electric fan, a television set, a refrigerator, a washing machine, an air cooler, an electric light, an electric door lock, an electric window, a camera, surveillance cameras such as closed-circuit television (CCTV) cameras, a media player, a stereo system, a pet feeding machine, a coffeemaker, a heater, a water tap, etc. The method disclosed herein facilitates network communication, information management of utility appliances, utility appliance automation, etc. The method disclosed herein allows a user device, for example, a smartphone, a tablet computer, or another mobile device to remotely control and monitor one or more utility appliances, for example, home appliances from indoor locations and outdoor locations.

The method disclosed herein comprises providing 101 an appliance control device configured to operably communicate with an appliance management system accessible on a user device via a local network, for example, the WiFi® network of Wi-Fi Alliance Corporation. As used herein, “appliance control device” refers to an embedded device that allows a user device to communicate with a load terminal relay unit that is connected to multiple utility appliances via a local network, thereby allowing the user device to remotely manage and control the utility appliances. In an embodiment, the appliance management system comprises an appliance management application executable by at least one processor on a user device. In another embodiment, the appliance management application of the appliance management system is accessible to the user device via a communication network, for example, the internet. As used herein, “appliance management application” refers to a mobile application configured to operate on a user device, for example, a smartphone, a tablet computer, or another mobile device, and receive user inputs to remotely manage and control the utility appliances. In the method disclosed herein, the operable communication between the appliance management system accessible on the user device and the appliance control device allows efficient control of the utility appliances with different levels of operation and allows a user to carry out day-to-day activities at ease.

In an embodiment, a networking device establishes the local network to operably communicate with the appliance control device and the appliance management system accessible on the user device to exchange data. The networking device is, for example, a router, a modem, a gateway, etc. The user device with internet connectivity communicates with the networking device, for example, a WiFi® modem positioned inside a home environment. The networking device is configured to check presence of the appliance control device to exchange data with the appliance control device. The networking device automatically sends data to and receives data from the load terminal relay unit operably connected to the appliance control device via the local network, and transmits the data to the appliance management system on receiving a request from the appliance management system via the local network. Since the utility appliances are accessible to the user device via the appliance control device over the local network, a user can control these utility appliances from any location via the appliance management system installed on the user device.

The appliance control device, for example, a Wi-Fi® enabled appliance control device operably communicating with the networking device controls and monitors the utility appliances. The method disclosed herein comprises connecting multiple utility appliances to one appliance control device as opposed to multiple conventional plugs that are available in the market that allow only one connection to only one utility appliance at a time. Once the appliance control device is connected to the networking device, the appliance control device is ready to send and receive data through the local network, for example, a WiFi® communication network. The appliance management system accessible on the user device communicates with the appliance control device, for example, via WiFi® connectivity. The appliance control device acts as an intermediate between the appliance management system accessible on the user device and the utility appliances via the networking device that creates the local network, thereby allowing the user device to remotely manage and control the utility appliances.

The appliance control device is further configured to operably communicate with and control the utility appliances via the load terminal relay unit. The load terminal relay unit is configured to manage and control loading of the utility appliances on receiving a control data signal from the appliance control device. The load terminal relay unit updates, for example, an on or off status of each of the utility appliances operably connected to the load terminal relay unit to the appliance control device, which in turn transmits an updated status of each of the utility appliances to the appliance management system accessible on the user device via the local network. The load terminal relay unit allows connection of the utility appliances to the networking device. The networking device relays appliance control data converted to command or control data signals by the appliance control device to the corresponding utility appliances that are connected to the load terminal relay unit. By using the networking device for establishing the communication between the appliance management system accessible on the user device and the appliance control device connected to the utility appliances via the load terminal relay unit, the response time is substantially fast for controlling loading of the utility appliances and data uploading between the appliance management system and the appliance control device.

In an embodiment, the appliance control device communicates a network connection status to the appliance management system accessible on the user device. That is, the appliance control device communicates whether a network connection to the local network is established, to the appliance management system. The appliance control device communicates 102 an activation status of each utility appliance to the appliance management system via the local network. As used herein, “activation status” refers to a power status of a utility appliance at an instance of time based on alternating current (AC) loading of the utility appliance at that instance. The appliance control device receives 103 appliance control data for controlling one or more utility appliances based on the communicated activation status from the appliance management system via the local network. The appliance control data comprises control inputs provided by a user to remotely manage and control one or more utility appliances. In an embodiment, the appliance control data is a string command in string format. The appliance control device converts the string format of the appliance control data into a serial data format. In an embodiment, the networking device converts the string format of the appliance control data into a serial data format and transmits the converted appliance control data in the serial data format to the appliance control device.

The appliance control device processes 104 the received appliance control data to generate a control data signal. The control data signal is configured to indicate one or more actions to be performed by the utility appliances. The actions to be performed by actuation of the utility appliances comprise, for example, powering the utility appliances, powering the utility appliances after a predefined time period, deactivating the utility appliances, controlling one or more operational parameters associated with the utility appliances, etc. The operational parameters comprise, for example, temperature, speed, light intensity, image capture, security, light color, channels of an entertainment utility appliance such as a television set, volume, etc., and any combination thereof. The appliance control device transmits 105 the generated control data signal to the load terminal relay unit for actuating the utility appliances to perform the actions. In an embodiment, the appliance control device generates a confirmation message configured to indicate a current activation status of each utility appliance. After actuating the utility appliances based on the generated control data signal to perform the actions, the appliance control device transmits the generated confirmation message to the appliance management system accessible on the user device via the local network.

In an embodiment, the appliance control device dynamically updates and stores the activation status of each utility appliance for enabling actuation of the utility appliances to perform the actions indicated in the generated control data signal on an occurrence of an electric power restoration from a power source. The appliance control device stores, for example, an alternating current (AC) load status of each utility appliance in an inbuilt memory unit of the appliance control device. For example, on an occurrence of a total power cut, the appliance control device instructs the load terminal relay unit to switch on utility appliances such as a light and a fan after the electric power restoration from the power source. On the occurrence of the electric power restoration from the power source, the appliance control device retrieves the activation status stored in the inbuilt memory unit of the appliance control device, and switches on the utility appliances based on the stored activation status of each of the utility appliances.

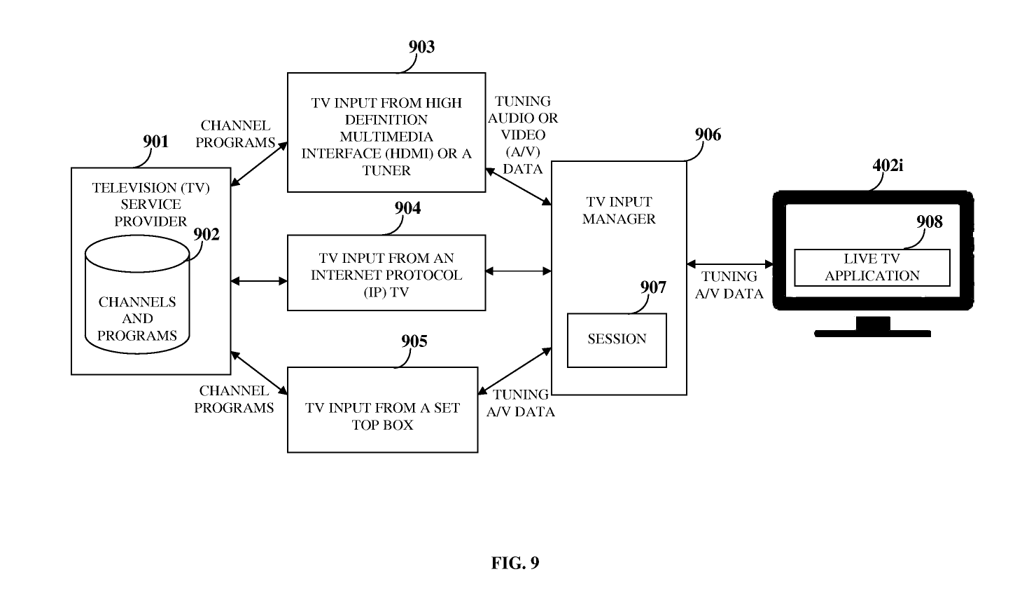

In an embodiment, the method disclosed herein comprises establishing an infrared communication between the appliance management system accessible on the user device and the appliance control device and/or the utility appliances to allow the appliance management system to remotely manage and control the utility appliances as disclosed in the detailed description of FIG. 9.

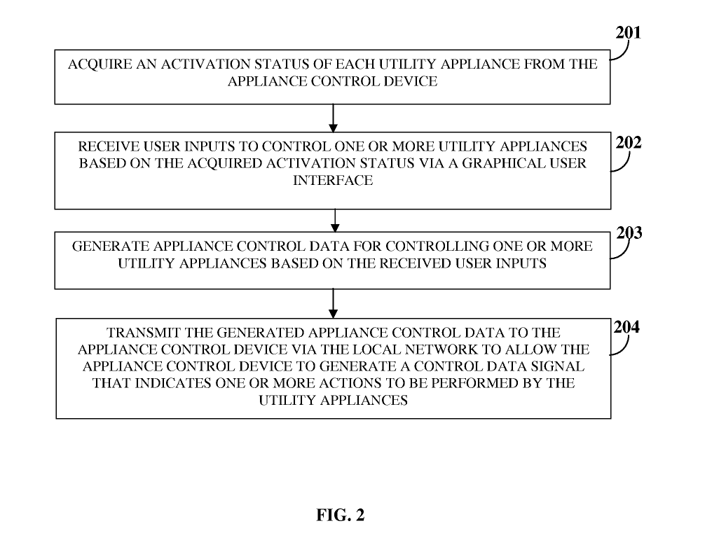

FIG. 2 illustrates a computer implemented method for remotely managing and controlling one or more of multiple utility appliances using the appliance management system. The computer implemented method disclosed herein employs the appliance management system comprising at least one processor configured to execute computer program instructions for remotely managing and controlling one or more of multiple utility appliances. The appliance management system is accessible on a user device. The appliance management system comprises the appliance management application downloadable on the user device or accessible by the user device via a communication network, for example, the internet. In an embodiment, the appliance management application is developed, for example, on a mobile platform such as an Android development framework or an iOS development framework. In an embodiment, the appliance management application is developed, for example, as an Android application or an iOS application. In an embodiment, the appliance management application is developed using as an integrated development environment, for example, Eclipse of Eclipse Foundation, Xcode® of Apple Inc., etc. The appliance management system accessible on the user device communicates with the appliance control device through the networking device. The appliance management system enables user devices to manage and control a variety of utility appliances, for example, home appliances that are connected to the appliance control device via the local network, for example, through Wi-Fi® connectivity.

When the appliance management system is invoked on the user device, the appliance management system searches for network connectivity, for example, router connectivity to the networking device, and establishes communication with the networking device. The appliance management system then establishes a communication with the appliance control device via the local network created by the networking device. When the communication between the appliance management system and the appliance control device is established, the appliance control device can be controlled by a user using the appliance management system, for example, installed on the user device to control the utility appliances connected to the appliance control device via the load terminal relay unit. In an embodiment, the appliance management system activates a graphical user interface (GUI) on the user device based on a network connection status of the appliance control device. That is, the appliance management system activates the GUI on the user device for receiving user inputs, when the appliance control device is connected to the local network. Further, the appliance management system activates the GUI on the user device when the appliance control device and the user device have established a connection, for example, a wireless connection via the networking device.

The appliance management system accessible on the user device acquires 201 an activation status of each utility appliance from the appliance control device via the local network. The appliance management system is in operable communication with the appliance control device via the local network. When the appliance management system accessible on the user device sends data to the networking device, the networking device updates a status of the appliance control device to the appliance management system and vice versa. The appliance control device operably communicates with and controls one or more utility appliances via the load terminal relay unit. In an embodiment, the appliance management system receives a confirmation message indicating a current activation status of each utility appliance from the appliance control device on the GUI via the local network.

In an embodiment, the appliance management system renders and activates one or more interface elements associated with the utility appliances recognized by the appliance management system on the GUI of the appliance management system based on the acquired activation status of each utility appliance. The interface elements are, for example, icons, buttons, images, etc., representing the utility appliances and functions associated with the utility appliances. The appliance management system applies and executes a user interface (UI) design on the user device where the utility appliances can be managed and controlled with the associated interface elements activated on the GUI of the appliance management system. In an embodiment, the interface elements allow a user to control on and off functions of the utility appliances via the GUI of the appliance management system. In an embodiment, the appliance management system facilitates addition of one or more utility appliances to be controlled by the appliance control device via the GUI. The appliance management system allows a user to explore and add multiple utility appliances via the GUI. During addition of a new utility appliance, for example, a bedroom light, a kitchen light, etc., the user can input additional information associated with the added utility appliance via the GUI.

The appliance management system receives 202 user inputs to control one or more of the utility appliances based on the acquired activation status via the GUI provided by the appliance management system. The appliance management system generates 203 appliance control data for controlling the utility appliances based on the received user inputs. In an example, the appliance management system accessible on the user device transmits control inputs in the form of appliance control data, for example, to enable temperature control of an air conditioner, speed control, camera control, motion surveillance management of security cameras, security management and control of a door locking system, control color changes in light bulbs, remote power on or off of a heater, and/or control of any other utility appliance such as a television set that can be controlled by using a remote. In another example, a Wi-Fi® enabled home monitoring camera fitted in a room can be monitored and controlled by the appliance management system on the user device. A user can view live feeds received from a camera on the GUI of the appliance management system on the user device.

The appliance management system transmits 204 the generated appliance control data to the appliance control device via the local network to allow the appliance control device to generate a control data signal that indicates one or more actions to be performed by the utility appliances by processing the generated appliance control data. The appliance control device transmits the generated control data signal to the load terminal relay unit for actuating the utility appliances to perform the indicated actions. In an embodiment, the appliance management system transmits the appliance control data to the appliance control device, for example, in string format via the local network established by the networking device.

In an embodiment, the computer implemented method disclosed herein provides an agent server configured to operably communicate with the appliance management system accessible on the user device via a communication network, for example, the internet. The agent server also communicates with one or more sensors operably connected to the appliance control device via the local network established by the networking device. The agent server is further configured to identify the user device, the appliance control device, and each of the sensors by an identification address, for example, an internet protocol address. In an embodiment, the agent server receives alert information from the sensors via the communication network and transmits the alert information to the appliance management system accessible on the user device via the communication network. The appliance management system accessible on the user device receives the alert information from the agent server via the communication network and alerts the user via the GUI.

In an embodiment, the appliance management system accessible on the user device transmits an image capture request to the appliance control device via the agent server over the communication network. The appliance control device generates and transmits a control data signal to an image capture device in operable communication with the appliance control device for capturing an image based on the image capture request. The appliance control device transmits the captured image to the agent server via the communication network. In an embodiment, the appliance management system receives the captured image from the agent server via the communication network.

In an embodiment, the appliance management system accessible on the user device configures the appliance control device based on supplementary user inputs received from the user device via GUI of the appliance management system for actuating one or more of the utility appliances to perform the actions indicated in the generated control data signal. For example, a user can customize and design a circuit of the appliance control device via the GUI of the appliance management system for controlling utility appliances such as a television set, a home theatre system, etc. The user can operate the customized appliance control device to which multiple utility appliances are connected and control these utility appliances via the appliance management system installed on the user device.

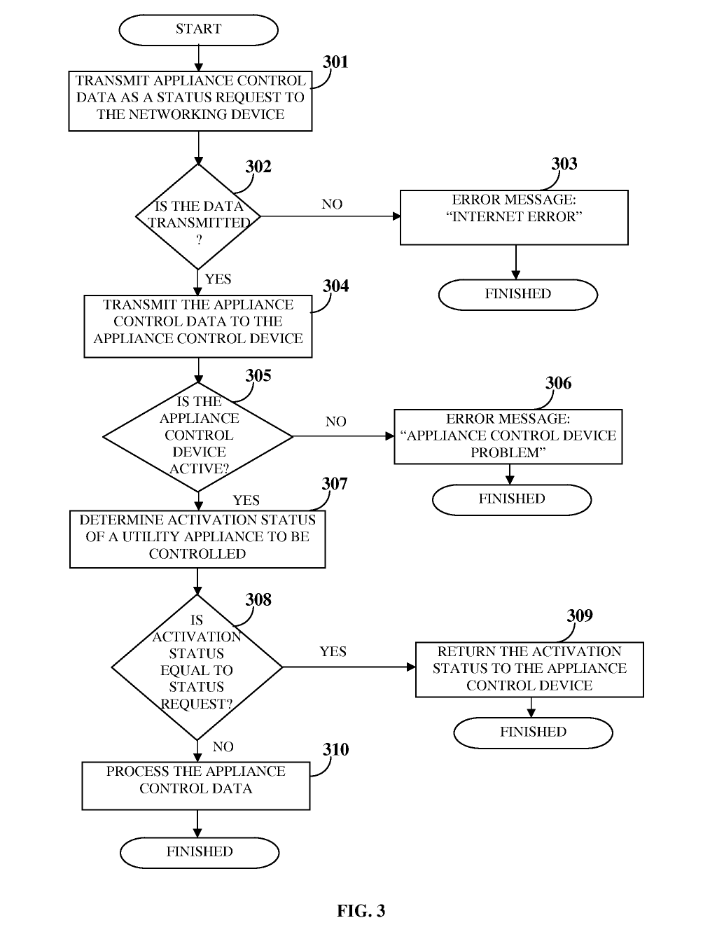

FIG. 3 exemplarily illustrates a flowchart comprising the steps involved in managing and controlling a utility appliance. The user device checks the presence of a networking device, for example, a WiFi® modem and internet connectivity provided by the networking device. The appliance management system transmits 301 appliance control data as a status request to the networking device. The appliance management system accessible on the user device checks 302 whether the appliance control data is transmitted. If the user device does not have internet connectivity, the appliance management system displays 303 an error message, for example, “Internet error”, on the graphical user interface (GUI) provided by the appliance management system.

If the appliance management system on the user device successfully connects to the networking device, then the appliance management system checks the activation status of the utility appliance and transmits 304 the appliance control data through the networking device to the appliance control device, for example, a WiFi® enabled appliance control device. After receiving the appliance control data from the appliance management system, the networking device transfers the received appliance control data to the appliance control device. The networking device checks 305 whether the appliance control device is active. If the appliance control device is not active and the networking device is unable to connect to the appliance control device, the networking device sends 306 an error message, for example, “appliance control device problem” to the appliance management system. The appliance management system receives the error message and displays the error message on the GUI. If the appliance control device is active and the networking device is connected to the appliance control device, the networking device transmits a notification to the appliance management system on the user device indicating successful communication with the appliance control device.

The appliance control device determines 307 the activation status of a utility appliance to be controlled. The appliance control device checks 308 whether the activation status of the utility appliance is equal to the appliance control data configured as the status request. If the activation status of the utility appliance is same as the status request, then the appliance control device does not process the appliance control data in the status request and returns 309 the activation status of the utility appliance to the appliance management system on the user device. If the activation status of the utility appliance is not the same as the status request, then the appliance control device processes 310 the appliance control data to generate a control data signal. The appliance control device transmits the control data signal to the load terminal relay unit operably connected to the utility appliance to actuate the utility appliance to perform an action indicated by the control data signal.

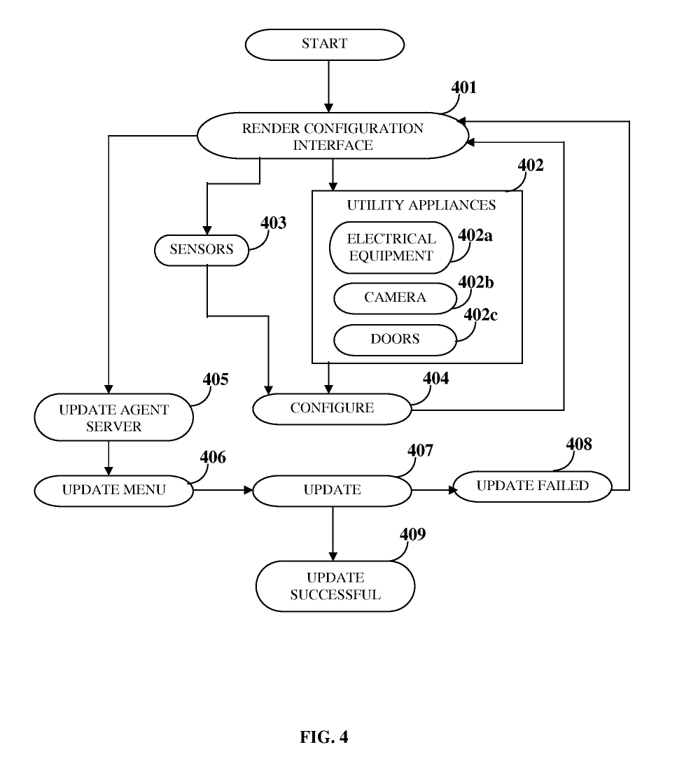

FIG. 4 exemplarily illustrates a flow diagram comprising the steps involved in configuring one or more sensors 403 and one or more utility appliances 402 in communication with the agent server. The appliance management system accessible on the user device communicates with the agent server via a communication network, for example, the internet. In an embodiment, the agent server is a centralized agent based server system that is managed by regional administrators and a superior administrator. The regional administrators are responsible for creating user accounts for regional users who use appliance control devices in their respective houses and the superior administrator is in charge of administering the work of all the regional administrators. In an embodiment, the agent server operates as a distributed server system where each region is associated with a server to serve users within each region. The server in a particular region communicates with appliance management systems accessible on user devices in that region and manages operations of appliance control devices used by the users in that region. The agent server links and differentiates the user devices, the sensors 403, and the appliance control devices operably connected to the utility appliances 402 by dissimilar internet protocol (IP) addresses.

Consider an example where a user wishes to configure, control, and supervise utility appliances 402 comprising, for example, electrical equipment 402a, a camera 402b, and doors 402c that are installed in the user's house. The user downloads the appliance management application of the appliance management system on the user device. The appliance management system operably communicates with the agent server via a communication network, for example, the internet. The agent server renders 401 a configuration interface on the graphical user interface (GUI) of the appliance management system on the user device. The user can add and configure 404 the electrical equipment 402a, the camera 402b, the doors 402c, and the sensors 403 on the configuration interface for controlling powering on and off operations of the electrical equipment 402a, an image capture operation of the camera 402b, lock and unlock functions of the doors 402c, and transmission of alerts by one or more sensors 403, via the GUI of the appliance management system. The appliance management system on the user device updates 405 the agent server with the configuration of the electrical equipment 402a, the camera 402b, the doors 402c, and the sensors 403. The appliance management system updates 406 menu interfaces on the GUI. The appliance management system checks 407 whether all the updates are successful. If an update has failed 408, the appliance management system redirects the user to the configuration interface via the GUI. The process of configuring the utility appliances 402 is complete once the updates are successful 409.

The appliance control device can be used to manage and control the sensors 403, for example, door sensors, passive infrared (PIR) sensors, etc., installed in the user's house. The sensors 403 can detect an unknown object entering or crossing an area covered by the sensors 403. The sensors 403 trigger alerts on sensing motion in the vicinity of the sensors 403. The sensors 403 transmit the triggered alerts as digital inputs to the appliance control device. The appliance control device communicates the received digital inputs to the agent server via the communication network. The agent server stores the received digital inputs in a database of the agent server. When the appliance management system accessible on the user device polls the agent server via the communication network, the appliance management system receives alert messages from the agent server and displays the alert messages on the GUI on the user device.

Consider another example where the appliance management system accessible on the user device allows the user to control locking of the doors 402c in the user's house via the GUI. The appliance management system accessible on the user device communicates with the appliance control device installed in the user's house via the local network established by the networking device such as a router. Door sensors are operably connected to the doors 402c in the user's house to track a state of each of the doors 402c. For example, the door sensors track the opening and closing of the doors 402c. The door sensors communicate with the appliance control device via the local network. In an embodiment, the appliance control device comprises, for example, a Raspberry Pi module developed by the Raspberry Pi Foundation. The door sensors communicate with the appliance control device via the Raspberry Pi module. The door sensors communicate an activation status, for example, an open status or a closed status of the doors 402c to the appliance control device via the local network. The appliance control device receives the activation status as a digital input. The appliance control device communicates the digital input to the appliance management system accessible on the user device via the local network. The appliance management system communicates with the agent server via the communication network to notify the status change of the doors 402c. Whenever a status change of the doors 402c is sensed by the door sensors, the door sensors transmit digital inputs to the appliance control device. The appliance control device communicates the status change to the appliance management system accessible on the user device via the local network. The appliance management system in turn notifies the agent server via the communication network.

Consider another example where a user wishes to configure passive infrared (PR) sensors using the appliance management system accessible on the user device. The PIR sensors are temperature sensitive and can detect motion of any warm object, for example, up to 10 meters (m) above the floor of the user's house. The PIR sensors can detect motion of the warm objects or passing by of the warm objects in the vicinity of the PIR sensors. The PR sensors are triggered by any form of thermal input interferences in the environment of the PIR sensors. The PIR sensors communicate with the appliance control device via the Raspberry Pi module of the appliance control device. The user can configure internal settings for different levels of sensing thermal objects in the vicinity of the PR sensors. In an embodiment, the user configures internal settings for different levels of sensing thermal objects in the vicinity of the PIR sensors directly through the Raspberry Pi module of the appliance control device. In another embodiment, the user configures internal settings for different levels of sensing thermal objects in the vicinity of the PR sensors through the GUI of the appliance management system accessible on the user device. The Raspberry Pi module of the appliance control device transmits alerts to the appliance management system as digital inputs via the local network when the PR sensors sense thermal changes in the vicinity of the PIR sensors. The PIR sensors transmits the digital inputs to the Raspberry Pi module when an idle state changes to sensed areas and vice versa, and the Raspberry Pi module sends corresponding alerts to the appliance management system accessible on the user device via the local network.

Consider another example where a user wishes to configure a camera 402b for remotely capturing images using the appliance management system accessible on the user device. The appliance management system receives user inputs via the GUI of the appliance management system for capturing images using the camera 402b. The user inputs comprise a user identifier (ID) and a camera ID. The appliance management system transmits the user inputs to the agent server via the communication network. The agent server stores the received user inputs in the database of the agent server. In an embodiment, the appliance management system temporarily stores the received user inputs in a temporary main table of the database. When the appliance control device polls the agent server via the communication network, the agent server transmits the stored user inputs to the appliance control device. The appliance control device processes the user inputs and generates and transmits a control data signal to the load terminal relay unit that is operably connected to the camera 402b to actuate the camera 402b. The camera 402b captures images based on an indication received from the load terminal relay unit. The appliance control device receives the captured image from the camera 402b and transmits the captured image to the agent server via the communication network. The agent server stores the captured image in the database, for example, under a name of the user. The temporary main table of the database creates and stores a record in the database to indicate the captured image. When the appliance management system accessible on the user device polls the agent server, the agent server transmits the stored captured image to the appliance management system accessible on the user device via the communication network. In an embodiment, the appliance management system on the user device can resize and display the captured image on the GUI.

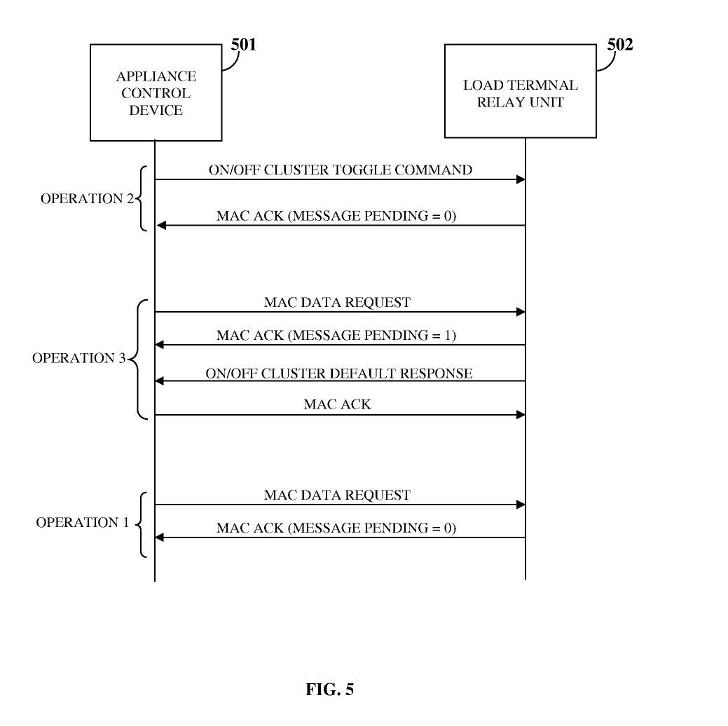

FIG. 5 exemplarily illustrates a sequence diagram showing a flow of data between the appliance control device 501 and the load terminal relay unit 502. The appliance control device 501 communicates with the load terminal relay unit 502 via a local network, for example, a communication network that implements ZigBee® of ZigBee Alliance Corporation. Consider an example for actuating a utility appliance such as a light in a user's house. In this example, the load terminal relay unit 502 functions as a light coordinator for actuating the light. The appliance control device 501 communicates control data signals with the load terminal relay unit 502, for example, using a ZigBee® stack operation. As exemplarily illustrated in FIG. 5, in a first ZigBee® stack operation, the appliance control device 501 first sends a control data signal as a media access control (MAC) data request to the load terminal relay unit 502 via the local network. The MAC data request is, for example, to check an activation status of the light. The load terminal relay unit 502 responds to the MAC data request by sending a MAC acknowledgement (ACK) response indicating, for example, a deactivated status of the light via the local network. The MAC ACK sent by the load terminal relay unit 502 indicates zero pending MAC data requests.

In a second ZigBee® stack operation, the appliance control device 501 transmits an on or off cluster toggle command to the load terminal relay unit 502 via the local network. Since the light is deactivated in this example, the appliance control device 501 sends an on cluster toggle command to the load terminal relay unit 502 via the local network. The load terminal relay unit 502 responds with a MAC ACK response to the appliance control device 501 via the local network, indicating receipt of the on cluster toggle command and zero pending MAC data requests. In a third ZigBee® stack operation, the appliance control device 501 transmits a MAC data request to the load terminal relay unit 502 to check an execution status of the on cluster toggle command via the local network. The load terminal relay unit 502 determines that the light cannot be powered on, for example, due to a power outage and sends a MAC ACK response indicating that execution of the on cluster toggle command is on hold until an occurrence of an electric power restoration from a power source. The MAC ACK response indicates that the MAC data request is pending. On an occurrence of the electric power restoration from the power source, the load terminal relay unit 502 powers on the light and transmits an on or off cluster default response, for example, in this case an on cluster default response to the appliance control device 501 via the local network. The appliance control device 501 sends a MAC ACK to the load terminal relay unit 502 via the local network, on receipt of the on cluster default response and indicating completion of the stack operation.

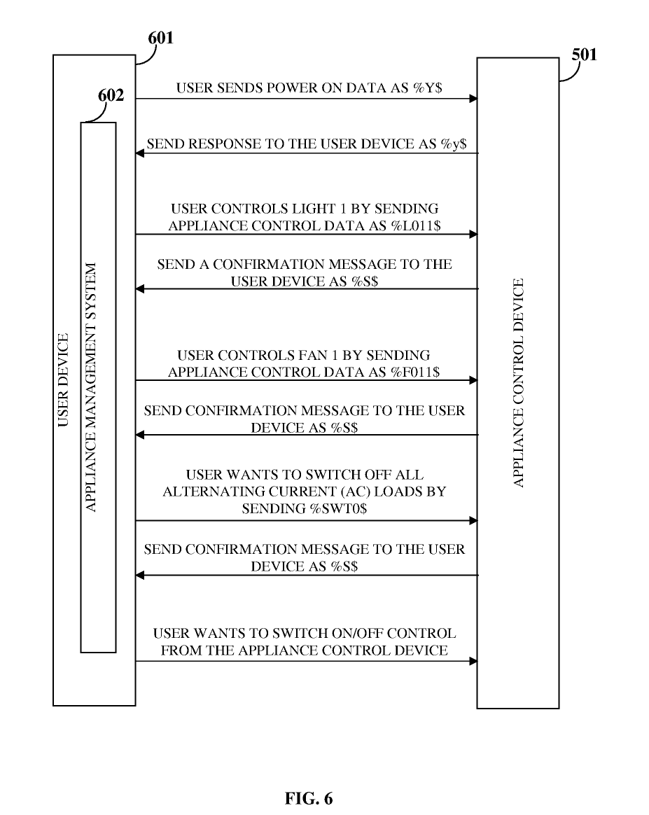

FIG. 6 exemplarily illustrates a sequence diagram showing flow of data between the appliance management system 602 accessible on a user device 601 and the appliance control device 501. The appliance management system 602 accessible on the user device 601 transmits internet protocol (IP) address serial data of the user device 601 to the networking device such as an Ethernet board of a modem. The user device 601 pings the networking device through the IP address of the user device 601. In an embodiment, the communication of data between the user device 601 and the appliance control device 501 is in a serial data format. An example of the acronyms used in generation of appliance control data by the appliance management system 602 is shown in the table below:

| | |
|---|---|
| % | Starting of a string |
| L | Indicates load |
| 01 | Indicates light number |
| 1/0 | Indicates switch on or off |
| $ | Ending of a string |

The networking device establishes communication between the user device 601 and the appliance control device 501 via the local network created by the networking device. Once the appliance control device 501 is powered on, the appliance control device 501 awaits appliance control data comprising, for example, appliance power on data from the appliance management system 602 on the user device 601 via the local network. The appliance management system 602 transmits the appliance power on data as “% Y$” to the appliance control device 501 via the local network. The appliance control device 501 transmits a response as “% y$” to the appliance management system 602. The appliance management system 602 then activates interface elements such as control icons associated with the utility appliances on the graphical user interface (GUI) of the appliance management system 602. If the appliance management system 602 does not receive the response to the power on data from the appliance control device 501, the appliance management system 602 does not enable the interface elements on the GUI. The user, for example, clicks on or touches a control icon, for example, for light 1 on the GUI. The appliance management system 602 generates appliance control data as a string “% L011$” and transmits the string “% L011$” to the appliance control device 501 via the local network. On receiving the string “% L011$” from the appliance management system 602, the appliance control device 501 generates and transmits a control data signal to the load terminal relay unit 502 exemplarily illustrated in FIG. 5, that is connected to light 1 to switch on light 1. If the user selects a control icon for turning off the light 1 on the GUI, the appliance management system 602 sends appliance control data as “% L010$” to the appliance control device 501 via the local network. Once the appliance control device 501 actuates light 1 via the load terminal relay unit 502, the appliance control device 501 transmits a confirmation message as “% S$” to the appliance management system 602 on the user device 601 via the local network.

In another example, if the user selects a control icon for powering on a fan 1 on the GUI, the appliance management system 602 transmits appliance control data as a string “% F011$” to the appliance control device 501. After switching on the fan 1 via the load terminal relay unit 502, the appliance control device 501 transmits a confirmation message as “% S$” to the appliance management system 602 on the user device 601 via the local network. In another example, if the user selects a control icon for switching off all alternating current (AC) loads via the GUI, the appliance management system 602 transmits appliance control data as a string “% SWT0$” to the appliance control device 501 via the local network. After turning off all the AC loads, the appliance control device 501 transmits a confirmation message as “% S$” to the appliance management system 602 on the user device 601 via the local network. If the user wishes to connect with or disconnect from the appliance control device 501, the appliance management system 602 sends appliance control data for switching the appliance control device 501 on or off via the local network.

Consider another example where a user wishes to remotely manage and control a single fan 1 located in room 1 of the user's house. The user logs into the appliance management system 602 on a user device 601, for example, a smartphone. The appliance management system 602 attempts to communicate with the networking device installed in the user's house. The internet protocol (IP) addresses and port numbers of the user device 601 and the appliance control device 501 are configured by the networking device. The networking device verifies the corresponding IP addresses and port numbers of the user device 601 and the appliance control device 501 to establish communication between the user device 601 and the appliance control device 501. The user inputs a command “Room1Fan1ON” via the graphical user interface (GUI) of the appliance management system 602 for controlling fan 1 in room 1. The appliance management system 602 generates appliance control data in a string format corresponding to the user inputted command. The appliance management system 602 transmits the generated appliance control data to the appliance control device 501 via the local network. The appliance control device 501 comprising a microcontroller unit processes the appliance control data to generate a control data signal and transmits the generated control data signal to the load terminal relay unit 502 that is connected to fan 1 in room 1. The load terminal relay unit 502 then turns on fan 1 in room 1. The appliance control device 501 sends a confirmation message to the appliance management system 602 on the user device 601 via the local network once fan 1 in room 1 is turned on.

Consider another example where a user wishes to remotely manage and control multiple utility appliances such as multiple fans in room 1. The networking device configures the IP addresses and port numbers of the user device 601 and the appliance control device 501 and verifies the configured IP addresses and port numbers to establish communication between the user device 601 and the appliance control device 501. The user inputs a command such as “Room1Fan1ON” for each fan in the room 1 via GUI of the appliance management system 602 for controlling each fan in room 1. The appliance management system 602 generates appliance control data in a string format corresponding to the user inputted commands. The appliance management system 602 checks connectivity of the user device 601 with the networking device and transmits the generated appliance control data to the appliance control device 501 via the local network. The microcontroller unit of the appliance control device 501 processes the appliance control data to generate a control data signal and transmits the generated control data signal to the load terminal relay unit 502 that is connected to the fans in room 1. The load terminal relay unit 502 then turns on the fans in room 1. The appliance control device 501 sends a confirmation message to the user device 601 via the local network once the fans in room 1 are turned on.

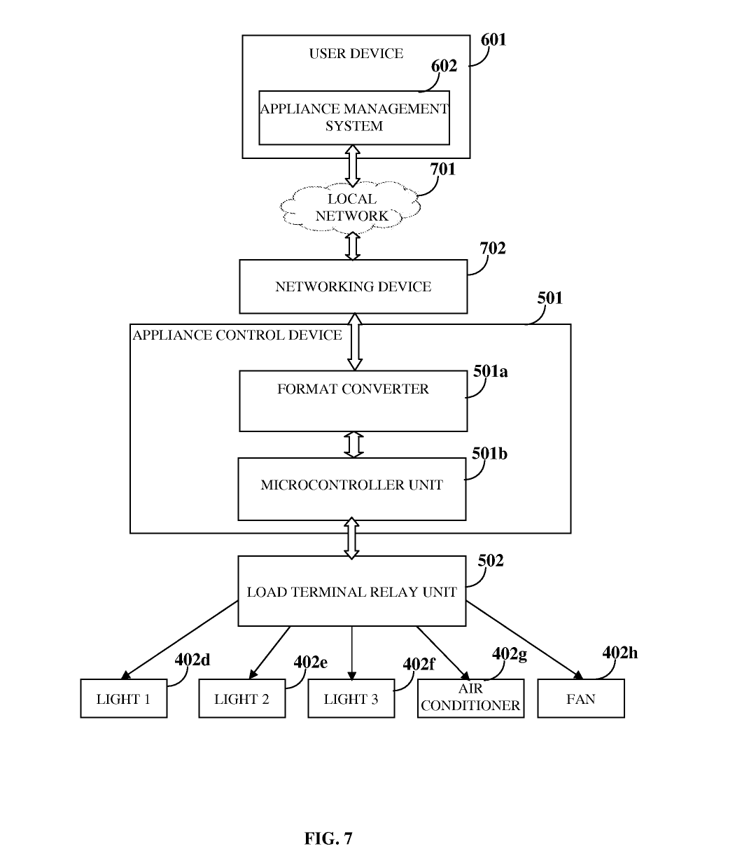

FIG. 7 exemplarily illustrates a work flow diagram showing communication between the appliance management system 602 accessible on a user device 601 and multiple utility appliances, for example, lights 402d, 402e, and 402f, an air conditioner 402g, and a fan 402h via the appliance control device 501 over a local network 701. When a user wants to activate one or more utility appliances 402d, 402e, 402f, 402g, and 402h, the user logs into the appliance management system 602 on the user device 601 via a graphical user interface (GUI) provided by the appliance management system 602. The user device 601 and the appliance control device 501 ping the networking device 702, for example, a Wi-Fi® modem, via a local network 701, for example, WiFi® communication network created by the networking device 702 for network connectivity. The networking device 702 configures and verifies internet protocol (IP) addresses and port numbers of the user device 601 and the appliance control device 501 to pair the user device 601 and the appliance control device 501 with the networking device 702. The networking device 702 creates the local network 701 for establishing communication between the user device 601, the appliance control device 501, the load terminal relay unit 502, and the utility appliances 402d, 402e, 402f, 402g, and 402h. The appliance management system 602 on the user device 601 connects to the appliance control device 501 via the local network 701. The appliance control device 501 comprises a format converter 501a, for example, a serial to Ethernet converter, and a microcontroller unit 501b. The format converter 501a, for example, is a Stellaris° Serial to Ethernet designer kit of Texas Instruments. The format converter 501a augments communication with legacy embedded utility appliances 402d, 402e, 402f, 402g, and 402h, where each of the utility appliances 402d, 402e, 402f, 402g, and 402h comprise only one serial port as a control interface or a configuration interface. The microcontroller unit 501b of the appliance control device 501 is configured, for example, as a microcontroller board.

The networking device 702 receives appliance control data as string commands from the appliance management system 602 implemented in the user device 601 via the local network 701. The networking device 702 forwards the received appliance control data to the format converter 501a of the appliance control device 501. The format converter 501a converts embedded data received from the appliance management system 602 into serial data. In an embodiment, if the received appliance control data is not in a serial data format, the format converter 501a converts the appliance control data into serial data. The format converter 501a transmits the converted appliance control data to the microcontroller unit 501b of the appliance control device 501. The microcontroller unit 501b processes the appliance control data to control alternating current (AC) loading of the utility appliances 402d, 402e, 402f, 402g, and 402h based on the appliance control data. The microcontroller unit 501b processes the appliance control data to generate a control data signal that indicates powering on or off of the utility appliances 402d, 402e, 402f, 402g, and 402h. The microcontroller unit 501b transmits the generated control data signal to the load terminal relay unit 502 to power on or off the utility appliances 402d, 402e, 402f, 402g, and 402h. In an embodiment, the microcontroller unit 501b stores the AC load status of the utility appliances 402d, 402e, 402f, 402g, and 402h in a local memory unit. The microcontroller unit 501b transmits a confirmation message to the user device 601 via the local network 701 on successful execution of the generated control data signal by the load terminal relay unit 502.

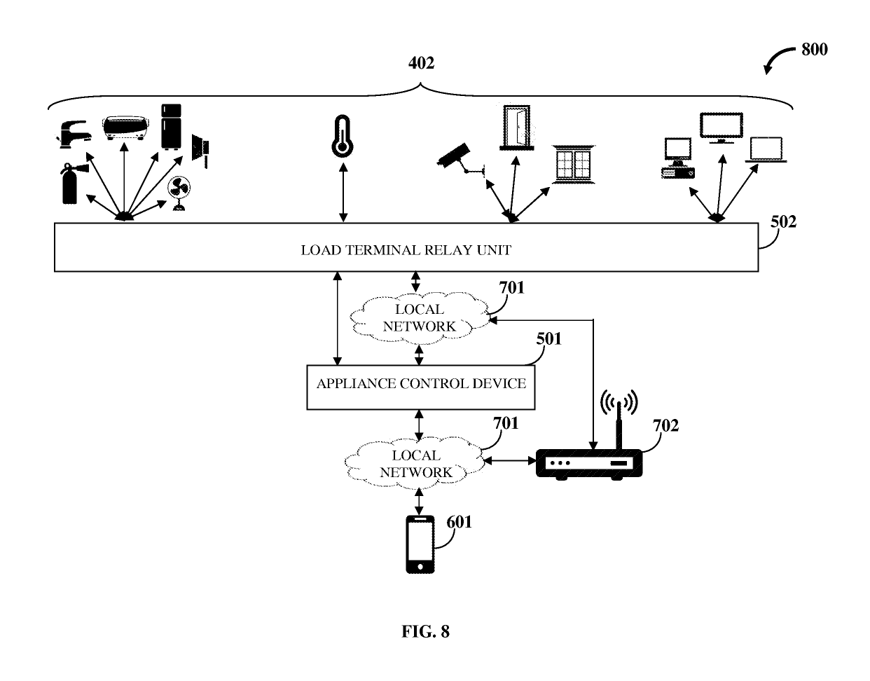

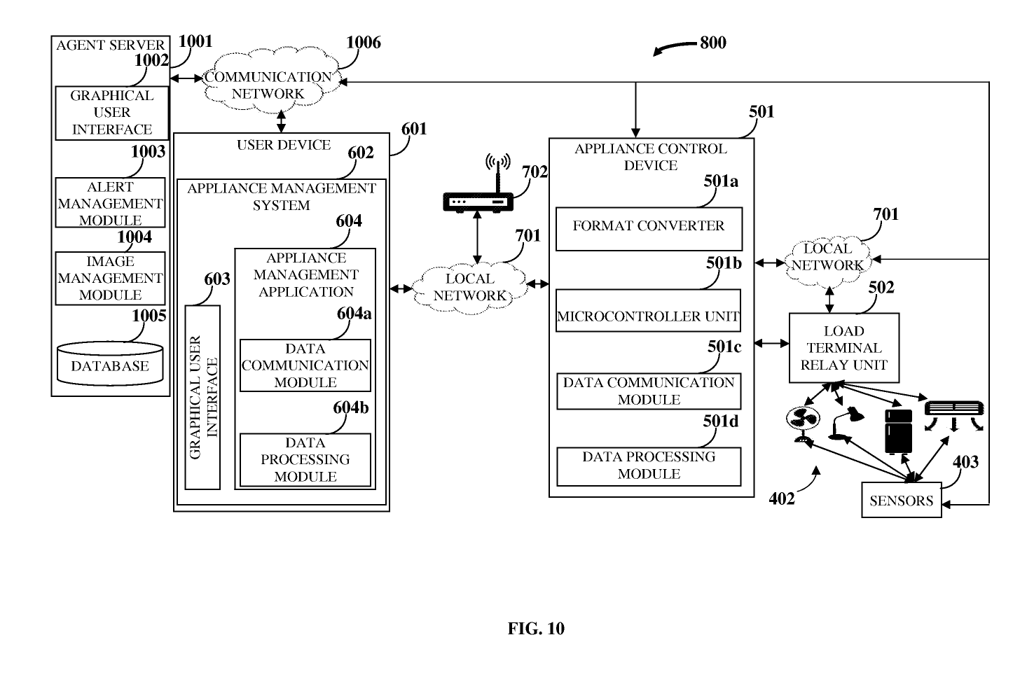

FIG. 8 exemplarily illustrates a system 800 for remotely managing and controlling one or more of multiple utility appliances 402. The utility appliances 402 comprise, for example, home appliances such as water taps, electric toasters, refrigerators, lights, electric fans, fire extinguishers, etc., environmental sensors such as temperature sensors, security appliances such as automatic door locks, surveillance cameras, windows, etc., media appliances such as media players, television sets, computing devices, etc. The system 800 disclosed herein comprises the appliance management system 602 incorporated in a user device 601 as exemplarily illustrated in FIG. 7 and FIG. 10, and the appliance control device 501. The networking device 702 such as a router or a gateway is incorporated in the system 800 disclosed herein to create a local network 701 for establishing communication between the user device 601 and the appliance control device 501. The networking device 702 operates as a bridge that interconnects utility appliances 402 to the appliance control device 501 configured, for example, as an internet enabled Raspberry Pi open source hardware unit. In an embodiment, the Raspberry Pi open source hardware unit is provided on a Raspberry Pi module development board.

In an embodiment, the Raspberry Pi open source hardware unit comprises, for example, a Linux® operating system to perform the functions of the appliance control device 501. The Raspberry Pi open source hardware unit is configured to connect to the utility appliances 402. In an embodiment, a user can directly and manually control the Raspberry Pi open source hardware unit without the use of the appliance management system 602 accessible on the user device 601. In this embodiment, the Raspberry Pi open source hardware unit comprises a push button that can be activated by the user for controlling the Raspberry Pi open source hardware unit. In an embodiment, the utility appliances 402 are ZigBee® powered devices and nodes that communicate with the internet enabled Raspberry Pi open source hardware unit of the appliance control device 501 having the Linux® operating system. Communication between the utility appliances 402 and the appliance control device 501 over the ZigBee® local network allows easy and flexible connectivity between adjacent nodes in the ZigBee® local network.

The format converter 501a of the appliance control device 501 exemplarily illustrated in FIG. 7, receives appliance control data from the appliance management system 602 accessible on the user device 601 via the local network 701. In an embodiment, the appliance control data is, for example, an embedded Ethernet data packet structure. The format converter 501a converts the embedded Ethernet data packet structure into 8 bytes in serial port communication. Each byte represents a utility appliance 402 that a user wishes to control as specified in the appliance control data transmitted by the appliance management system 602. The microcontroller unit 501b of the appliance control device 501 exemplarily illustrated in FIG. 7, is, for example, a CC3000 integrated circuit (IC) of Texas Instruments that performs intercommunication between, for example, the Raspberry Pi module of the appliance control device 501 and the networking device 702. The CC3000 IC does not use, for example, 0, 1, 2, 4, and 5 bytes of the appliance control data transmitted from the user device 601 to the appliance control device 501. The CC3000 IC allows the appliance control device 501 to fetch, for example, a service set identifier (SSID), a gateway address, a key, and a device name of each of the utility appliances 402.

In an embodiment, the appliance control device 501 communicates with the load terminal relay unit 502 via the local network 701 as exemplarily illustrated in FIG. 8. The load terminal relay unit 502 comprises, for example, a buck and boost converter unit such as the TPS61291 low IQ boost converter of Texas Instruments with a bypass operation for power management and maintenance of load safety of the utility appliances 402. In an embodiment, the low IQ boost converter enables a loading condition, light loading efficiency, synchronous rectification, etc., for the utility appliances 402. The low IQ boost converter requires, for example, about 0.9 volts (V) to about 5 V for input voltage and 20 mill amperes (mA) at a start up voltage of 1.5 V. In an embodiment, the appliance control device 501 is directly connected to the load terminal relay unit 502 as exemplarily illustrated in FIG. 8. The appliance management system 602 sends appliance control data to the appliance control device 501 via the local network 701. The appliance control device 501 processes the appliance control data and generates a control data signal that indicates one or more actions to be performed by the utility appliances 402. The appliance control device 501 transmits the control data signal to the load terminal relay unit 502 directly or wirelessly via the local network 701.

The load terminal relay unit 502 communicates with the utility appliances 402 directly. In an embodiment, the load terminal relay unit 502 is connected to the utility appliances 402 wirelessly via the local network 701. The load terminal relay unit 502 actuates the utility appliances 402 to perform the actions indicated in the control data signal. The appliance control device 501, in communication with the load terminal relay unit 502, transmits a confirmation message to the appliance management system 602 accessible on the user device 601 via the local network 701. The appliance management system 602 displays the confirmation message on the graphical user interface (GUI) on the user device 601.

FIG. 9 exemplarily illustrates an embodiment of the system 800 shown in FIG. 8, for remotely managing and controlling a utility appliance, for example, a television (TV) set 402i. Consider an example where a user wishes to remotely manage and control a TV set 402i using a user device 601, for example, a smartphone exemplarily illustrated in FIG. 8. The user downloads the appliance management application of the appliance management system 602 exemplarily illustrated in FIG. 7 and FIG. 10, on the smartphone. The user's smartphone and the TV set 402i, each comprise an infrared (IR) transceiver configured to establish IR communication between the smartphone and the TV set 402i. Smartphones, for example, the iPhone® 5, 5S, 6, or 6+ of Apple Inc., a smartphone with the Android operating system, the Nexus® 5, 7, or 9 of Google Inc., etc., that comprise inbuilt IR sensors can be used in this embodiment of the system 800. With the help of the IR transceivers, the smartphone implementing the appliance management system 602 functions as a remote through which the TV set 402i can be managed and controlled. The IR transceivers of the smartphone communicate with an external IR transceiver that communicates with the IR transceivers of the TV set 402i. In an example, the user can power on or off the TV set 402i, switch channels, control volume, manage favorite channels, browse through channels, configure TV display settings, etc., via the GUI of the appliance management system 602 on the smartphone.

In this embodiment, the appliance control device 501 exemplarily illustrated in FIGS. 7-8, is not required. A separate IR transceiver is used in this implementation to manage and control the TV set 402i. In an embodiment, the IR transceivers can be purchased from a third party vendor. The TV set 402i and the smartphones have inbuilt IR transceivers and communication is established through the aforementioned IR transceivers. Hence, when a user wishes to change a channel in the TV set 402i, he or she can use the appliance management application of the appliance management system 602, downloaded on the smartphone to change the channels. An IR signal from the IR transceiver of the smartphone is sent to the external IR transceiver, which in turn transmits the IR signal to the TV set 402i. The TV set 402i accepts the IR signal via its own IR transceiver. The communication between the user's smartphone and the TV set 402i is established by the IR transceivers of each of the smartphone and the TV set 402i and the external IR transceiver. In this embodiment, the appliance management system 602 provides a live TV application 908 executable on the TV set 402i. The user can connect the TV set 402i to the networking device 702 exemplarily illustrated in FIGS. 7-8, for example, a Wi-Fi® modem, and download the live TV application 908 on the TV set 402i. The live TV application 908 communicates with a TV input manager 906 that manages inputs received from the smartphone for managing TV channels, programs, or TV settings. In an embodiment, the appliance management application configured as a universal remote application on the user device 601 comprises the TV input manager 906. The TV input manager 906 configures controller settings of the TV set 402i.

The user subscribes to a TV service provider 901 that provides channels and programs 902. The TV service provider 901 provides TV channels and programs 902 to the TV set 402i via a TV media communication input interfaces, for example, a high definition multimedia interface (HDMI), an internet protocol (IP) TV interface, a set top box, etc. The TV input manager 906 receives tuning audio and/or video data from the TV inputs 903, 904, and 905 of the HDMI, the IP TV interface, and the set top box. The TV input manager 906 allows the user to create TV sessions 907 of channels and programs 902 provided by the TV service provider 901 and communicate the tuning audio and/or video data to the live TV application 908 on the TV set 402i.

FIG. 10 exemplarily illustrates software and hardware components of the system 800 for remotely managing and controlling one or more of multiple utility appliances 402. The system 800 disclosed herein comprises the appliance management system 602 accessible on a user device 601, and the appliance control device 501. The user device 601 is an electronic device, for example, a personal computer, a tablet computing device, a mobile computer, a mobile phone, a smart phone, a portable computing device, a laptop, a personal digital assistant, a touch centric device, a workstation, a portable electronic device, a network enabled computing device, an interactive network enabled communication device, any other suitable computing equipment, and combinations of multiple pieces of computing equipment. The appliance management system 602 accessible on the user device 601 communicates with the appliance control device 501 via the networking device 702. In an embodiment, the appliance management system 602 comprises the appliance management application 604 configured as a software downloadable on the user device 601. The appliance management system 602 is accessible to users, for example, through a broad spectrum of technologies and devices such as personal computers with access to the internet, internet enabled cellular phones, tablet computing devices, etc.

The networking device 702, for example, a router, a modem, a gateway, etc., establishes a local network 701 for operably communicating with the appliance control device 501 and the appliance management system 602 accessible on the user device 601 to exchange data. In an embodiment, the networking device 702 is configured to operate in a serial communications protocol, for example, the Modbus™ protocol of Schneider Electric USA, Inc., that can be used for future data storage applications and can be used, for example, in facility management to enable communications between the appliance management system 602 on the user device 601 and the appliance control device 501 that is connected to multiple utility appliances 402 via the load terminal relay unit 502. In an embodiment, the communication established by the networking device 702, for example, can be configured to operate with an RS 232 based interlink, an RS 485 based interlink, or a universal serial bus (USB) based interlink. The local network 701 is, for example, the internet, an intranet, a wired network, a wireless network, a network that implements Wi-Fi®, an ultra-wideband communication network (UWB), a wireless universal serial bus (USB) communication network, a communication network that implements ZigBee® of ZigBee Alliance Corporation, a local area network, an internet connection network, an infrared communication network, etc., or a network formed from any combination of these networks.

The appliance management system 602 is in operable communication with the appliance control device 501 via the local network 701. The appliance management system 602 comprises a non-transitory computer readable storage medium and at least one processor communicatively coupled to the non-transitory computer readable storage medium. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium is configured to store computer program instructions defined by modules, for example, 604a, 604b, etc., of the appliance management system 602. The processor is configured to execute the defined computer program instructions.

The appliance management system 602 comprises the graphical user interface (GUI) 603 and the appliance management application 604. The GUI 603 is, for example, a webpage of a website hosted by the appliance management system 602, an online web interface, a web based downloadable application interface, a mobile based downloadable application interface, etc. The GUI 603 is activated on the user device 601 based on a network connection status of the appliance control device 501. In an embodiment, the GUI 603 facilitates addition of one or more of the utility appliances 402 to be controlled by the appliance control device 501. The appliance management application 604 comprises a data communication module 604a and a data processing module 604b. The data communication module 604a of the appliance management application 604 acquires an activation status of each utility appliance 402 from the appliance control device 501 via the local network 701. In an embodiment, the data processing module 604b of the appliance management application 604 renders and activates one or more interface elements associated with the utility appliances 402 recognized by the appliance management system 602 on the GUI 603 of the appliance management system 602 based on the acquired activation status of each utility appliance 402. The data communication module 604a receives user inputs to control one or more of the utility appliances 402 based on the acquired activation status via the GUI 603. The data processing module 604b generates appliance control data for controlling the utility appliances 402 based on the received user inputs. The data communication module 604a transmits the generated appliance control data to the appliance control device 501 via the local network 701.

In an embodiment, the data processing module 604b of the appliance management application 604 configures the appliance control device 501 based on supplementary user inputs received from the user device 601 via the GUI 603 of the appliance management system 602 for actuating the utility appliances 402 to perform the actions indicated in the generated control data signal.

The appliance control device 501 operably communicates with and controls the utility appliances 402 via the load terminal relay unit 502. The appliance control device 501 comprises the format converter 501a, for example, a serial to Ethernet converter, and the microcontroller unit 501b. The format converter 501a converts a string format of the appliance control data into a serial data format for transmission of the appliance control data to a data processing module 501d of the appliance control device 501. The microcontroller unit 501b is configured to execute computer program instructions defined by modules, for example, 501c, 501d, etc., of the appliance control device 501. The modules of the appliance control device 501 comprise a data communication module 501c and the data processing module 501d. In an embodiment, the data communication module 501c of the appliance control device 501 communicates a network connection status to the appliance management system 602 accessible on the user device 601.

The data communication module 501c of the appliance control device 501 receives the transmitted appliance control data for controlling the utility appliances 402 based on the acquired activation status from the appliance management system 602 via the local network 701. The data processing module 501d of the appliance control device 501 processes the received appliance control data for generating a control data signal that indicates one or more actions to be performed by the utility appliances 402. The data communication module 501c of the appliance control device 501 transmits the generated control data signal to the load terminal relay unit 502 for actuating the utility appliances 402 to perform the indicated actions. In an embodiment, the appliance control device 501 communicates with the load terminal relay unit 502 via the local network 701. The load terminal relay unit 502 is connected to multiple utility appliances 402. The load terminal relay unit 502 comprises one or more conventional relay switches, for example, mechanical relay switches, digital relay switches, multi-way relay switches, etc., or any combination thereof. The load terminal relay unit 502 manages and controls loading of the utility appliances 402 on receiving the generated control data signal from the data communication module 501c of the appliance control device 501.

The appliance control device 501 further comprises a non-transitory computer readable storage medium communicatively coupled to the microcontroller unit 501b of the appliance control device 501. The non-transitory computer readable storage medium of the appliance control device 501 is configured to store computer program instructions defined by modules, for example, 501c, 501d, etc., of the appliance control device 501. In an embodiment, the non-transitory computer readable storage medium is configured to dynamically store the activation status of each utility appliance 402 for enabling the actuation of one or more utility appliances 402 to perform the actions indicated in the generated control data signal on an occurrence of an electric power restoration from a power source. In an embodiment, the data processing module 501d of the appliance control device 501 generates a confirmation message that indicates a current activation status of each utility appliance 402. The data communication module 501c of the appliance control device 501 transmits the generated confirmation message to the appliance management system 602 via the local network 701.

In an embodiment, the system 800 disclosed herein further comprises the agent server 1001 that communicates with the appliance management system 602, the appliance control device 501, and one or more sensors 403 via a communication network 1006. The communication network 1006 is, for example, the internet, an intranet, a wireless network, a network that implements WiFi®, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, etc., a local area network, a wide area network, an internet connection network, an infrared communication network, etc., or a network formed from any combination of these networks. The agent server 1001 is in operable communication with the appliance management system 602 accessible on the user device 601 via the communication network 1006, and with the sensors 403 operably connected to the appliance control device 501 via the local network 701. The agent server 1001 is configured to identify the user device 601, the appliance control device 501, and each of the sensors 403 by an identification address, for example, an internet protocol address. The agent server 1001 comprises a graphical user interface (GUI) 1002, an alert management module 1003, an image management module 1004, and a database 1005. The GUI 1002 of the agent server 1001 is, for example, a webpage of a website hosted by the agent server 1001, an online web interface, a web based downloadable application interface, a mobile based downloadable application interface, etc. The alert management module 1003 receives alert information from the sensors 403 via the communication network 1006. The alert management module 1003 transmits the alert information to the appliance management system 602 accessible on the user device 601 via the communication network 1006.

The image management module 1004 of the agent server 1001 transmits an image capture request received from the appliance management system 602 accessible on the user device 601 to the appliance control device 501 over the communication network 1006. The appliance control device 501 generates and transmits a control data signal to an image capture device (not shown) in operable communication with the appliance control device 501 via the local network 701 for capturing an image based on the image capture request. The image management module 1004 receives the captured image from the appliance control device 501 via the communication network 1006. The image management module 1004 transmits the captured image to the appliance management system 602 accessible on the user device 601 via the communication network 1006. The GUI 1002 of the agent server 1001 allows regional and/or superior administrators to monitor alert information and captured images for managing and controlling utility appliances 402 via the communication network 1006.

The database 1005 is any storage area or medium that can be used for storing data and files, for example, the captured images, the alert information, etc. The database 1005 is, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In an embodiment, the database 1005 can also be a location on a file system. In another embodiment, the database 1005 can be remotely accessed by the agent server 1001 via the communication network 1006. In another embodiment, the database 1005 is configured as a cloud based database implemented in a cloud computing environment, where computing resources are delivered as a service over the communication network 1006, for example, the internet. As used herein, “cloud computing environment” refers to a processing environment comprising configurable computing physical and logical resources, for example, networks, servers, storage, applications, services, etc., and data distributed over the communication network 1006, for example, the internet. The cloud computing environment provides on-demand network access to a shared pool of the configurable computing physical and logical resources.

In an embodiment of the system 800 disclosed herein, each of the user device 601, the appliance control device 501, and the utility appliances 402 comprises inbuilt infrared transceivers configured to establish an infrared communication between the appliance management system 602 accessible on the user device 601 and the appliance control device 501 and/or the utility appliances 402 to allow the appliance management system 602 to remotely manage and control the utility appliances 402. In an embodiment, the appliance control device 501 is an infrared transceiver. In an embodiment, the appliance control device 501 is integrated in one or more of the utility appliances 402. The integrated appliance control device 501 in operable communication with the appliance management system 602 accessible on the user device 601 allows the user device 601 to remotely manage and control the utility appliances 402.

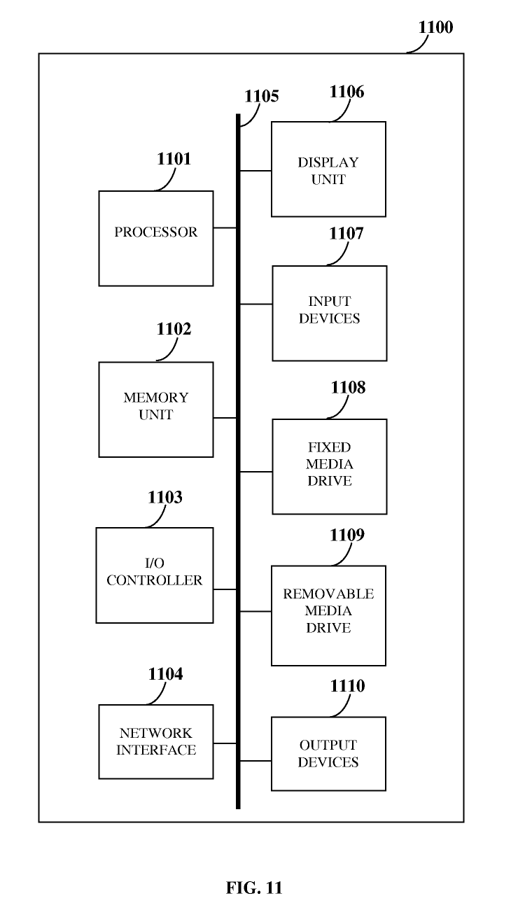

FIG. 11 exemplarily illustrates the architecture of a computer system 1100 employed by the appliance management system 602 exemplarily illustrated in FIG. 7 and FIG. 10, and the agent server 1001 exemplarily illustrated in FIG. 10, for remotely managing and controlling one or more utility appliances 402 exemplarily illustrated in FIG. 4, FIG. 8, and FIG. 10. The appliance management system 602 and the agent server 1001, each employ the architecture of the computer system 1100. The computer system 1100 is programmable using a high level computer programming language. The computer system 1100 may be implemented using programmed and purposeful hardware.

The computer system 1100 comprises, for example, a processor 1101, a non-transitory computer readable storage medium such as a memory unit 1102 for storing programs and data, an input/output (I/O) controller 1103, a network interface 1104, a data bus 1105, a display unit 1106, input devices 1107, a fixed media drive 1108 such as a hard drive, a removable media drive 1109 for receiving removable media, output devices 1110, etc. The processor 1101 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 1101 may also be implemented as a processor set comprising, for example, a general purpose microprocessor and a math or graphics co-processor. The processor 1101 is selected, for example, from the Intel® processors such as the Itanium® microprocessor or the Pentium® processors, Advanced Micro Devices (AMD®) processors such as the Athlon® processor, U1traSPARC® processors, microSPARC° processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The agent server 1001 and the appliance management system 602 disclosed herein are each not limited to a computer system 1100 employing a processor 1101. The computer system 1100 may also employ a controller or a microcontroller. The processor 1101 of the computer system 1100 of the agent server 1001 executes the modules, for example, 1003, 1004, etc., of the agent server 1001. The processor 1101 of the computer system 1100 of the user device 601 executes the modules, for example, 604a, 604b, etc., of the appliance management system 602.

The memory unit 1102 is used for storing programs, applications, and data. For example, the data communication module 604a and the data processing module 604b of the appliance management system 602 are stored in the memory unit 1102 of the computer system 1100 of the user device 601. The alert management module 1003 and the image management module 1004 of the agent server 1001 are stored in the memory unit 1102 of the computer system 1100 of the agent server 1001. The memory unit 1102 is, for example, a random access memory (RAM) or another type of dynamic storage device that stores information and instructions for execution by the processor 1101. The memory unit 1102 also stores temporary variables and other intermediate information used during execution of the instructions by the processor 1101. The computer system 1100 further comprises a read only memory (ROM) or another type of static storage device that stores static information and instructions for the processor 1101. The I/O controller 1103 controls input actions and output actions performed by each of the appliance management system 602 and the agent server 1001.

The network interface 1104 enables connection of the computer system 1100 to the communication network 1006 and the local network 701 exemplarily illustrated in FIG. 10. For example, the appliance management system 602 connects to the local network 701 via the network interface 1104, and the agent server 1001 communicates with the communication network 1006 via the network interface 1104. In an embodiment, the network interface 1104 is provided as an interface card also referred to as a line card. The network interface 1104 comprises, for example, one or more of an infrared (IR) interface, an interface implementing WiFi®, a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/ internet protocol (IP), interfaces based on wireless communications technology such as satellite technology, radio frequency (RF) technology, near field communication, etc. The data bus 1105 of the computer system 1100 of the user device 601 permits communications between the modules, for example, 603, 604a, 604b, etc., of the appliance management system 602. The data bus 1105 of the computer system 1100 of the agent server 1001 permits communications between the modules, for example, 1002, 1003, 1004, etc., of the agent server 1001.

The display unit 1106 of the computer system 1100 of the user device 601, via the graphical user interface (GUI) 603 exemplarily illustrated in FIG. 10, displays information, display interfaces, user interface elements such as text fields, checkboxes, text boxes, windows, etc., for allowing a user to enter user inputs comprising, for example, a selection of a utility appliance, for example, 402a, 402b, 402c, etc., exemplarily illustrated in FIG. 4, a status of the utility appliance, for example, 402a, 402b, 402c, etc., inputs for controlling the utility appliances, for example, 402a, 402b, 402c, etc. The display unit 1106 of the computer system 1100 of the agent server 1001, via the graphical user interface (GUI) 1002 exemplarily illustrated in FIG. 10, displays information, display interfaces, user interface elements such as text fields, checkboxes, text boxes, windows, etc., for allowing an administrator to manage and control appliance control devices 501 in a particular region. The display unit 1106 comprises, for example, a liquid crystal display, a plasma display, an organic light emitting diode (OLED) based display, etc. The input devices 1107 are used for inputting data into the computer system 1100. The users use the input devices 1107 to provide user inputs to the appliance management system 602 on the user device 601. For example, a user may enter a description for a utility appliance, for example, 402a, 402b, 402c, etc., a location of the utility appliance, for example, 402a, 402b, 402c, etc., in the user's home, a time of actuation of the utility appliance, for example, 402a, 402b, 402c, etc., using the input devices 1107. Administrators use the input devices 1107 to provide inputs to the agent server 1001. For example, an administrator may enter profile accounts for appliance control devices 501 installed in different users' houses using the input devices 1107. The input devices 1107 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 1100. The programs are loaded onto the fixed media drive 1108 and into the memory unit 1102 of the computer system 1100 via the removable media drive 1109. In an embodiment, the computer applications and programs may be loaded directly via the communication network 1006 or the local network 701. Computer applications and programs are executed by double clicking a related icon displayed on the display unit 1106 using one of the input devices 1107. The output devices 1110 output the results of operations performed by the agent server 1001 and the appliance management system 602. For example, the appliance management system 602 renders interface elements associated with the utility appliances, for example, 402a, 402b, 402c, etc., an activation status of each of the utility appliances, for example, 402a, 402b, 402c, etc., to users using the output devices 1110.

The processor 1101 executes an operating system, for example, the Linux® operating system, the Unix® operating system, any version of the Microsoft® Windows® operating system such as Microsoft® Windows® 2008 with hypertext preprocessor (PHP) hosting capabilities, the Mac OS® of Apple Inc., the IBM® OS/2, VxWorks® of Wind River Systems, Inc., QNX Neutrino® developed by QNX Software Systems Ltd., Palm OS®, the Solaris operating system developed by Sun Microsystems, Inc., the Android operating system, the Windows Phone® operating system of Microsoft Corporation, the BlackBerry® operating system of Blackberry Limited, the iOS operating system of Apple Inc., the Symbian® operating system of Symbian Foundation Limited, etc. The computer system 1100 employs the operating system for performing multiple tasks. The operating system is responsible for management and coordination of activities and sharing of resources of the computer system 1100. The operating system further manages security of the computer system 1100, peripheral devices connected to the computer system 1100, and network connections. The operating system employed on the computer system 1100 recognizes, for example, inputs provided by the users and administrators using one of the input devices 1107, the output display, files, and directories stored locally on the fixed media drive 1108. The operating system on the computer system 1100 executes different programs using the processor 1101. The processor 1101 and the operating system together define a computer platform for which application programs in high level programming languages are written.

The processor 1101 of the computer system 1100 of the user device 601 retrieves instructions defined by the data communication module 604a, the data processing module 604b, etc., of the appliance management system 602 for performing respective functions disclosed in the detailed description of FIG. 10. The processor 1101 retrieves instructions for executing the modules, for example, 604a, 604b, etc., of the appliance management system 602 from the memory unit 1102. The processor 1101 of the computer system 1100 employed by the agent server 1001 retrieves instructions defined by the alert management module 1003 and the image management module 1004 of the agent server 1001 for performing respective functions disclosed in the detailed description of FIG. 10. The processor 1101 retrieves instructions for executing the modules, for example, 1003, 1004, etc., of the agent server 1001 from the memory unit 1102. A program counter determines the location of the instructions in the memory unit 1102. The program counter stores a number that identifies the current position in the program of each of the modules, for example, 604a, 604b, etc., of the appliance management system 602. The program counter stores a number that identifies the current position in the program of each of the modules, for example, 1003, 1004, etc., of the agent server 1001. The instructions fetched by the processor 1101 from the memory unit 1102 after being processed are decoded. The instructions are stored in an instruction register in the processor 1101. After processing and decoding, the processor 1101 executes the instructions, thereby performing one or more processes defined by those instructions.

At the time of execution, the instructions stored in the instruction register are examined to determine the operations to be performed. The processor 1101 then performs the specified operations. The operations comprise arithmetic operations and logic operations. The operating system performs multiple routines for performing a number of tasks required to assign the input devices 1107, the output devices 1110, and memory for execution of the modules, for example, 604a, 604b, etc., of the appliance management system 602, and for execution of the modules, for example, 1003, 1004, etc., of the agent server 1001. The tasks performed by the operating system comprise, for example, assigning memory to the modules, for example, 604a, 604b, etc., of the appliance management system 602, and to the modules, for example, 1003, 1004, etc., of the agent server 1001, and to data used by the appliance management system 602 and the agent server 1001 separately, moving data between the memory unit 1102 and disk units, and handling input/output operations. The operating system performs the tasks on request by the operations and after performing the tasks, the operating system transfers the execution control back to the processor 1101. The processor 1101 continues the execution to obtain one or more outputs. The outputs of the execution of the modules, for example, 604a, 604b, etc., of the appliance management system 602 are displayed to the user on the display unit 1106 of the user device 601. The outputs of the execution of the modules, for example, 1003, 1004, etc., of the agent server 1001 are displayed to the user on the display unit 1106 of the computer system 1100 of the agent server 1001.

For purposes of illustration, the detailed description refers to the appliance management system 602 and the agent server 1001, each being run locally on the computer system 1100; however the scope of the method and system 800 disclosed herein is not limited to the appliance management system 602 and the agent server 1001, each being run locally on the computer system 1100 via the operating system and the processor 1101, but they may be extended to run remotely over the communication network 1006 by employing a web browser and a remote server, a mobile phone, or other electronic devices. One or more portions of the computer system 1100 may be distributed across one or more computer systems (not shown) coupled to the communication network 1006.

Disclosed herein is also a computer program product comprising a non-transitory computer readable storage medium that stores computer program codes comprising instructions executable by at least one processor 1101 for remotely managing and controlling the utility appliances 402 exemplarily illustrated in FIG. 4, FIG. 8, and FIG. 10. The computer program product comprises a first computer program code for communicating an activation status of each of the utility appliances 402 to the appliance management system 602 accessible on a user device 601 via a local network 701 exemplarily illustrated in FIGS. 7-8 and FIG. 10; a second computer program code for receiving appliance control data for controlling the utility appliances 402 based on the communicated activation status from the appliance management system 602 via the local network 701; a third computer program code for processing the received appliance control data to generate a control data signal that indicates one or more actions to be performed by the utility appliances 402; and a fourth computer program code for transmitting the generated control data signal to the load terminal relay unit 502 exemplarily illustrated in FIGS. 7-8 and FIG. 10, for actuating the utility appliances 402 to perform the actions. The computer program product further comprises a fifth computer program code for dynamically updating and storing the activation status of each of the utility appliances 402 for actuating the utility appliances 402 to perform the actions indicated in the generated control data signal on an occurrence of an electric power restoration from a power source. The computer program product disclosed herein further comprises one or more additional computer program codes for performing additional steps that may be required and contemplated for remotely managing and controlling the utility appliances 402. In an embodiment, a single piece of computer program code comprising computer executable instructions performs one or more steps of the computer implemented method disclosed herein for remotely managing and controlling the utility appliances 402.

The computer program codes comprising computer executable instructions are embodied on the non-transitory computer readable storage medium. The processor 1101 of the computer system 1100 retrieves these computer executable instructions and executes them. When the computer executable instructions are executed by the processor 1101, the computer executable instructions cause the processor 1101 to perform the steps of the computer implemented method for remotely managing and controlling the utility appliances 402.

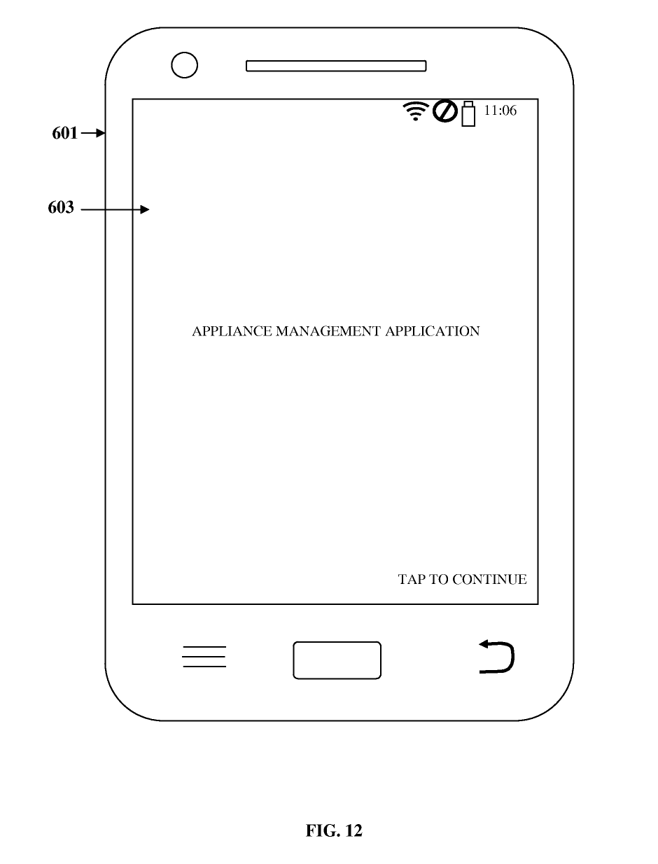

FIGS. 12-29 exemplarily illustrate wireframes displaying functional elements of the appliance management application 604 of the appliance management system 602 exemplarily illustrated in FIG. 10. The wireframes provide a blueprint of the content and layout of each page interface provided by the appliance management system 602.

FIG. 12 exemplarily illustrates a screenshot of a splash screen interface provided on the graphical user interface (GUI) 603 of the appliance management system 602 exemplarily illustrated in FIG. 10. A user can invoke the appliance management application 604 of the appliance management system 602 on the user device 601 exemplarily illustrated in FIG. 10, and can click on a “tap to continue” interface element displayed on the GUI 603 to proceed to a home page interface of the appliance management application 604.

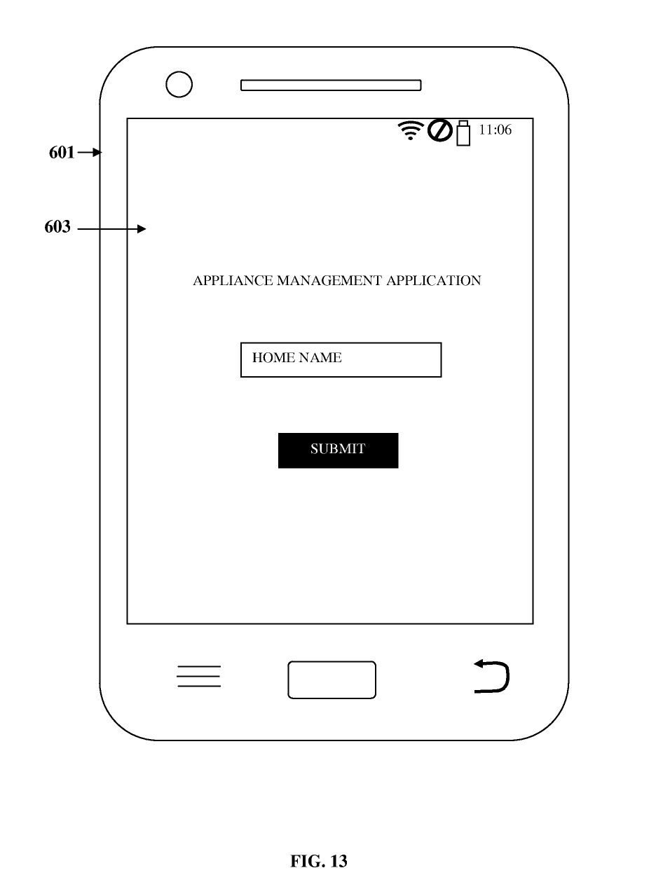

FIG. 13 exemplarily illustrates a screenshot of a home page interface provided on the graphical user interface (GUI) 603 of the appliance management system 602 exemplarily illustrated in FIG. 10. After navigating to the home page interface, the user can enter an identifier, for example, a user name, a home name, etc., to log into the user's account, and click on the “Submit” button on the GUI 603 to access the menu options provided by the appliance management application 604 of the appliance management system 602 exemplarily illustrated in FIG. 10.

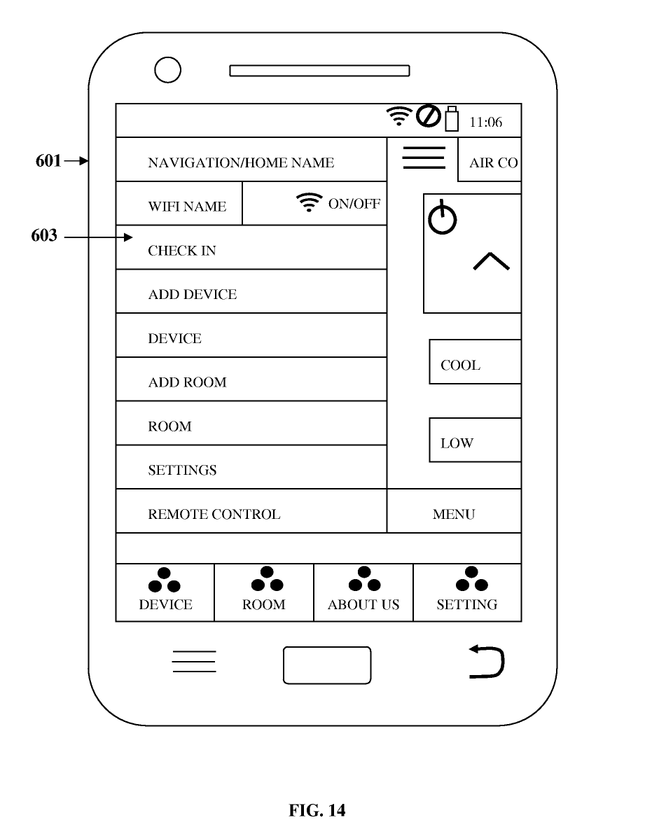

FIG. 14 exemplarily illustrates a screenshot of a graphical user interface (GUI) 603 provided by the appliance management system 602 on a user device 601 exemplarily illustrated in FIG. 10, showing multiple menu options for remote management and control of the utility appliances 402 exemplarily illustrated in FIG. 4, FIG. 8, and FIG. 10. As exemplarily illustrated in FIG. 14, an interface element, for example, a wireless network status indicator such as a Wi-Fi® indicator is displayed on a menu bar of the GUI 603. The Wi-Fi® indicator indicates connectivity of the user device 601 to the local network 701 exemplarily illustrated in FIGS. 7-8 and FIG. 10, that is, whether the Wi-Fi® local network is on or off on the user device 601. The Wi-Fi® indicator displays a Wi-Fi® name of the Wi-Fi® local network on the GUI 603 to indicate connectivity to the local network 701. The Wi-Fi® indicator is in a disabled state, for example, displayed as a disabled icon when there is no wireless connectivity to the local network 701. The GUI 603 also displays a check in menu option. The check in menu option, when clicked, refreshes the wireless connectivity and displays the state of enablement of the Wi-Fi® indicator. The GUI 603 also displays menu options, for example, for adding a device, for adding a room, for configuring settings, for remote control, etc.

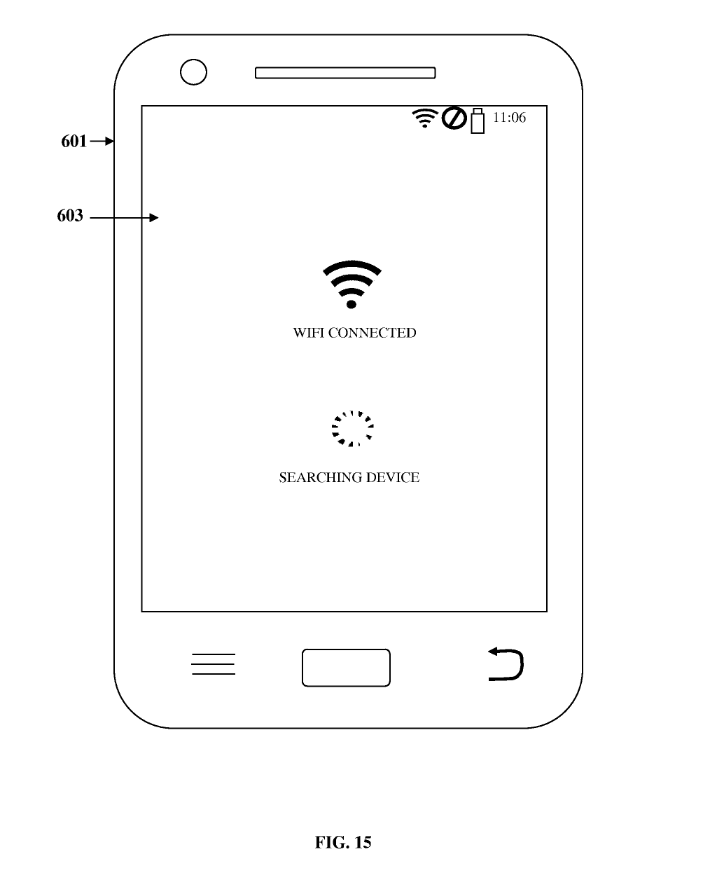

FIG. 15 exemplarily illustrates a screenshot of a search interface provided on the graphical user interface (GUI) 603 of the appliance management system 602 exemplarily illustrated in FIG. 10. Once the appliance management system 602 establishes connectivity to the local network 701 exemplarily illustrated in FIGS. 7-8 and FIG. 10, and receives a user input to search for a utility appliance via the GUI 603, the appliance management system 602 searches for the utility appliance via the local network 701 and displays the information of the utility appliance on the GUI 603.

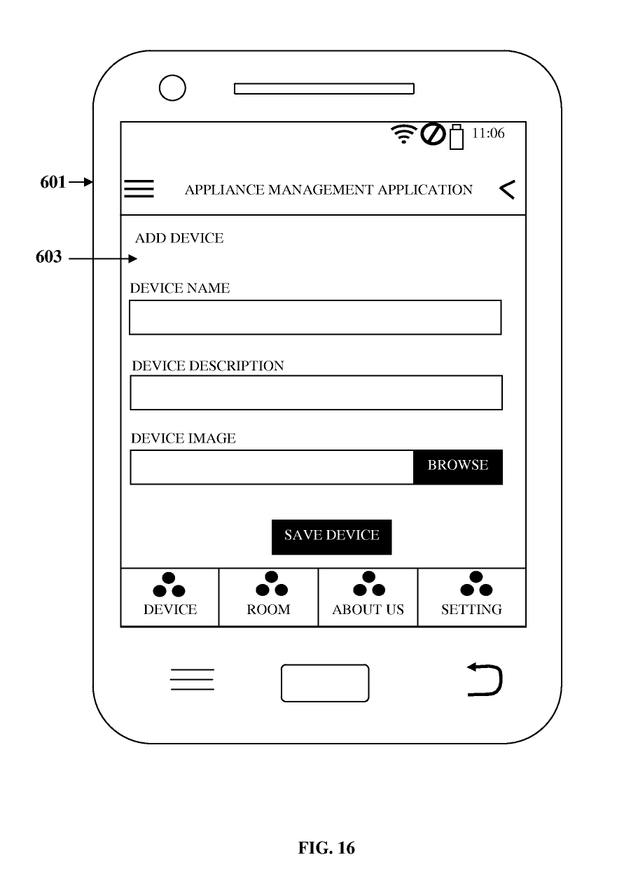

FIG. 16 exemplarily illustrates a screenshot of a device addition interface provided on the graphical user interface (GUI) 603 of the appliance management system 602 exemplarily illustrated in FIG. 10. The appliance management application 604 of the appliance management system 602 exemplarily illustrated in FIG. 10, invokes the device addition interface when a user clicks an add device menu option provided on the GUI 603 exemplarily illustrated in FIG. 14. The device addition interface facilitates addition of a utility appliance for remote management and control of the utility appliance. For adding a utility appliance, the appliance management application 604 of the appliance management system 602 receives information of the utility appliances to be added. The information of each utility appliance comprises, for example, a name, a description, an image, etc., of the utility appliance. The user can then save the information by clicking on a “save device” button provided on the GUI 603.

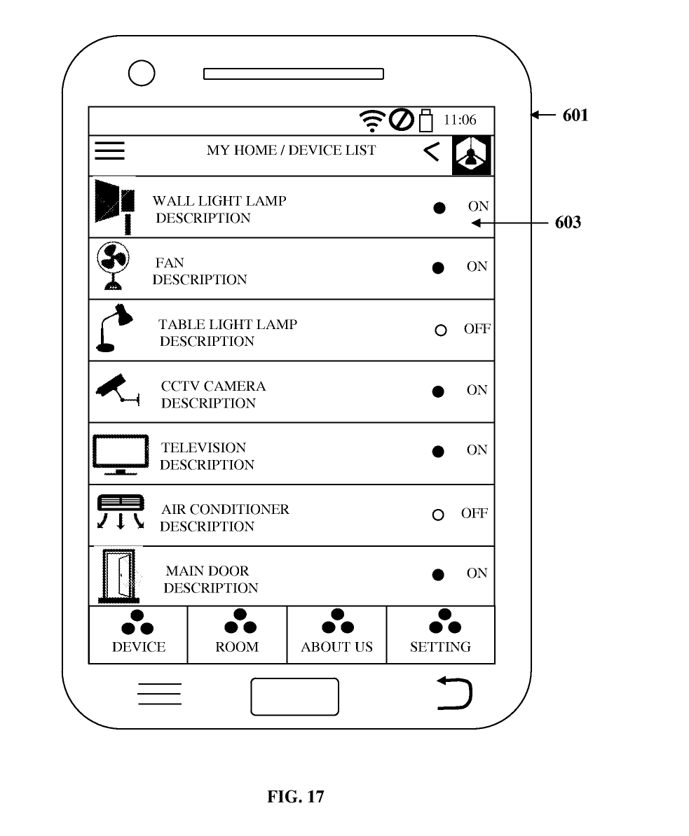

FIG. 17 exemplarily illustrates a screenshot of a device menu interface provided on the graphical user interface (GUI) 603 of the appliance management system 602 exemplarily illustrated in FIG. 10. The appliance management application 604 of the appliance management system 602 exemplarily illustrated in FIG. 10, invokes the device menu interface when a user clicks a device menu option provided on the GUI 603 exemplarily illustrated in FIG. 14. As exemplarily illustrated in FIG. 17, the device menu interface displays utility appliances added by the user to a user account for remote management and control of the utility appliances. The appliance management system 602 enables a user to log into the appliance management application 604, create a user profile or a user account, add multiple utility appliances, and associate the added utility appliances with the user account. As exemplarily illustrated in FIG. 17, the user adds utility appliances, for example, a wall light lamp, a fan, a table light lamp, a closed circuit television (CCTV) camera, a television, an air conditioner, a main door, etc., and associates the added devices with the user account named “my home”. The device menu interface enables a user to verify the information of each added utility appliance. The device menu interface also enables the user, for example, to select an added utility appliance, view information of the selected utility appliance, provide control inputs to perform actions on the selected utility appliance such as powering on or powering off of the utility appliance, changing the activation status via a power button provided on the GUI 603, etc.

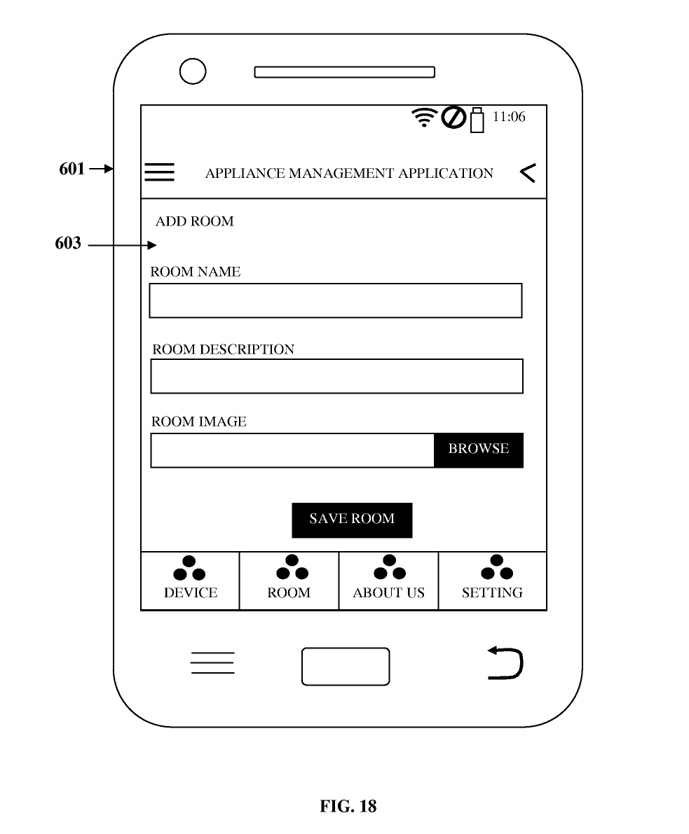

FIG. 18 exemplarily illustrates a screenshot of a room addition interface provided on the graphical user interface (GUI) 603 of the appliance management system 602 exemplarily illustrated in FIG. 10. The appliance management application 604 of the appliance management system 602 exemplarily illustrated in FIG. 10, invokes the room addition interface when a user clicks a room menu option provided on the GUI 603 exemplarily illustrated in FIG. 14. The room addition interface facilitates addition of one or more rooms and the utility appliances in the rooms for remote management and control of the utility appliances. For adding a room, the appliance management application 604 of the appliance management system 602 receives information of the room from the user. The information of the room comprises, for example, a room name, a room description, an image of the room, etc. The user can then save the information of the room by clicking on a “save room” button provided on the GUI 603.

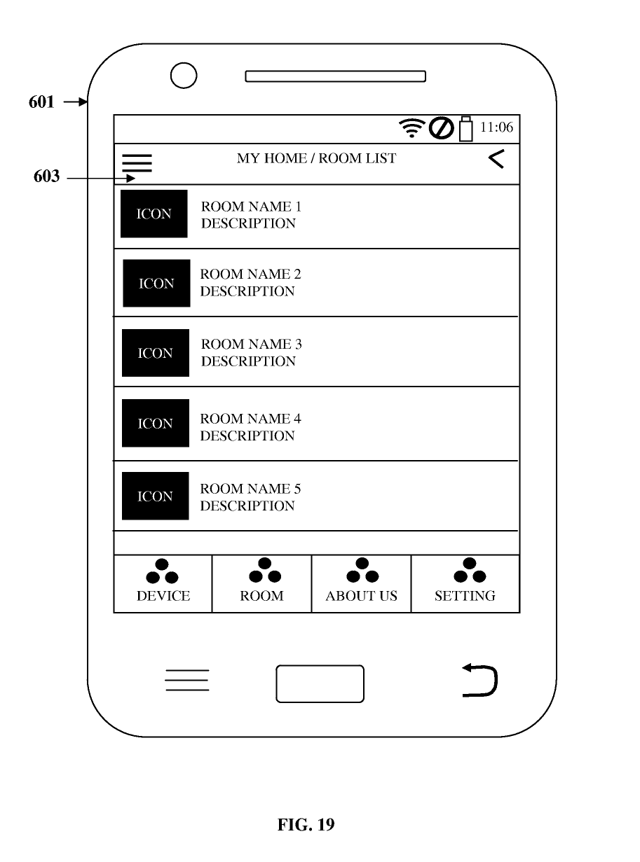

FIG. 19 exemplarily illustrates a screenshot of a room menu interface provided on the graphical user interface (GUI) 603 of the appliance management system 602 exemplarily illustrated in FIG. 10. The appliance management application 604 of the appliance management system 602 exemplarily illustrated in FIG. 10, invokes the room menu interface when a user clicks a room menu option provided on the GUI 603 exemplarily illustrated in FIG. 14. As exemplarily illustrated in FIG. 19, the room menu interface displays the rooms added by the user to the user account for remote management and control of the utility appliances in the rooms. The room menu interface enables a user to verify the information of the added rooms. Using the verified information, the appliance management system 602 remotely manages and controls the utility appliances in the room. The room menu interface facilitates room wise control of the utility appliances.

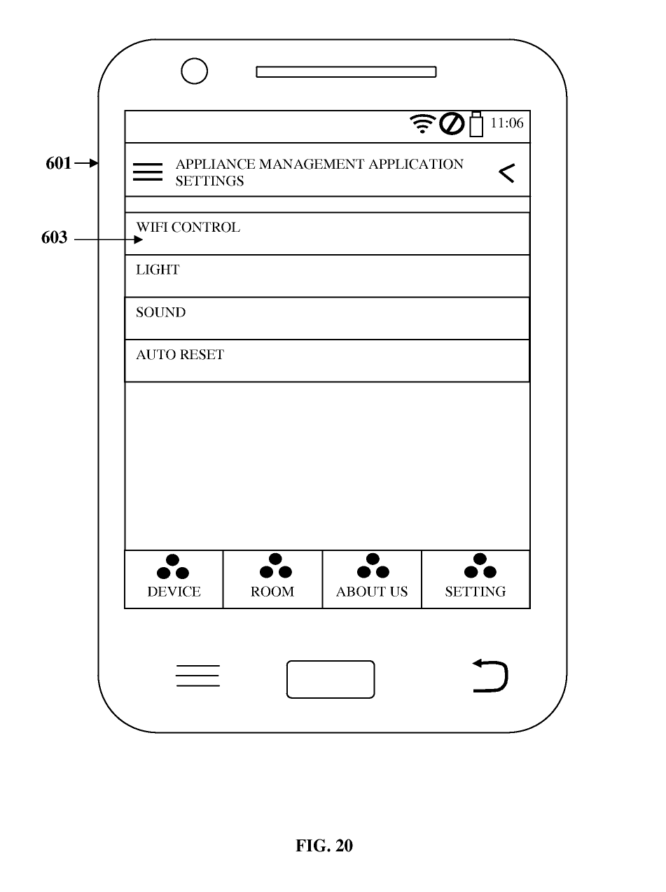

FIG. 20 exemplarily illustrates a screenshot of a settings menu interface provided on the graphical user interface (GUI) 603 of the appliance management system 602 exemplarily illustrated in FIG. 10. The appliance management application 604 of the appliance management system 602 exemplarily illustrated in FIG. 10, invokes the settings menu interface when a user clicks a settings menu option provided on the GUI 603 exemplarily illustrated in FIG. 14. The settings menu interface provides multiple settings options to the user. The settings options comprise, for example, WiFi® control settings such as Wi-Fi® internet protocol (IP) address control, light settings, sound settings, automatic reset of settings to default settings, etc.

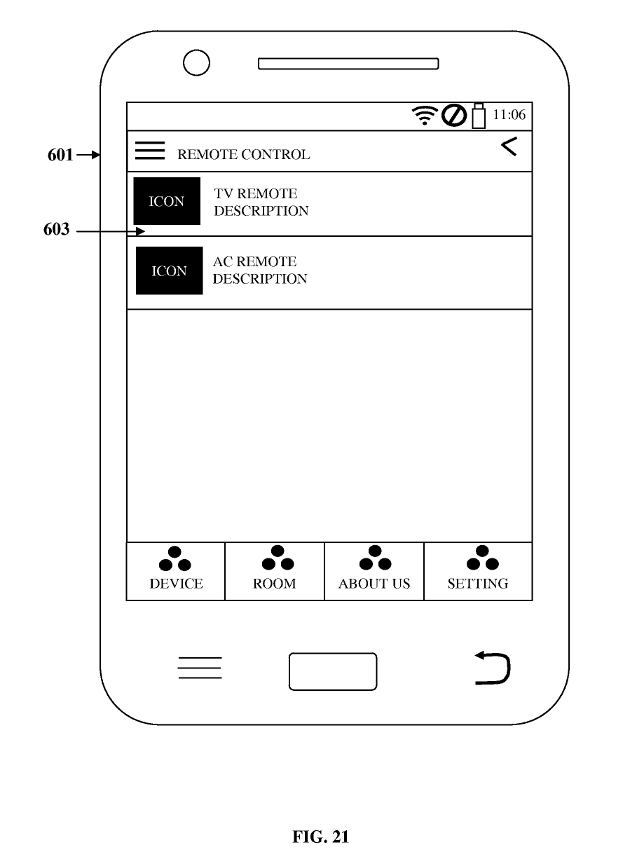

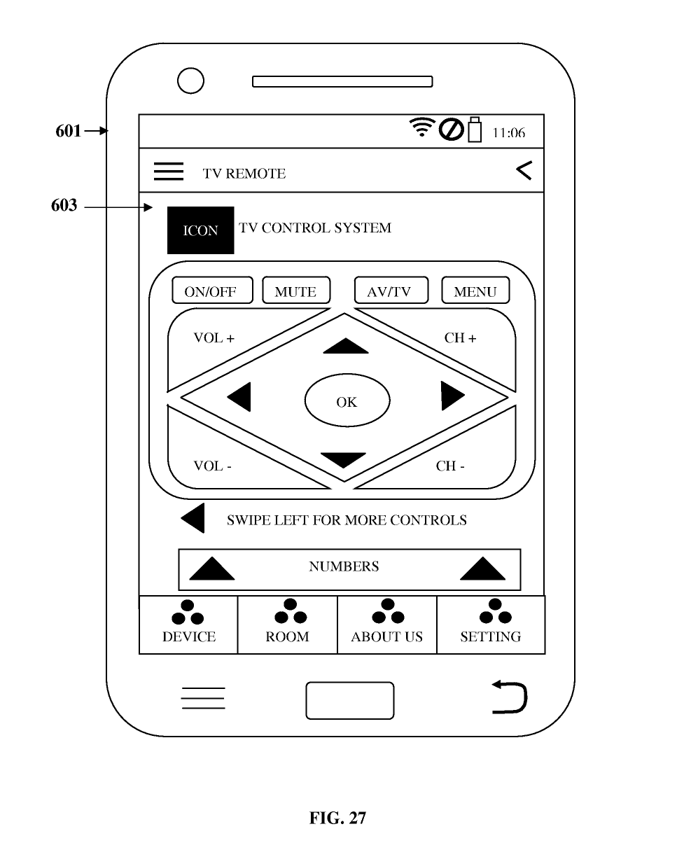

FIG. 21 exemplarily illustrates a screenshot of a remote control list interface provided on the graphical user interface (GUI) 603 of the appliance management system 602 exemplarily illustrated in FIG. 10. The appliance management application 604 of the appliance management system 602 exemplarily illustrated in FIG. 10, invokes the remote control list interface when a user clicks a remote control menu option provided on the GUI 603 exemplarily illustrated in FIG. 14. The remote control list interface displays a list of remote controls, for example, a television (TV) remote, an air conditioner (AC) remote, etc., configured for utility appliances, for example, a TV set, an air conditioner, etc., along with a description for each remote control as exemplarily illustrated in FIG. 21. A user can click on a remote control, for example, the TV remote via the GUI 603 to invoke a TV remote interface exemplarily illustrated in FIG. 27.

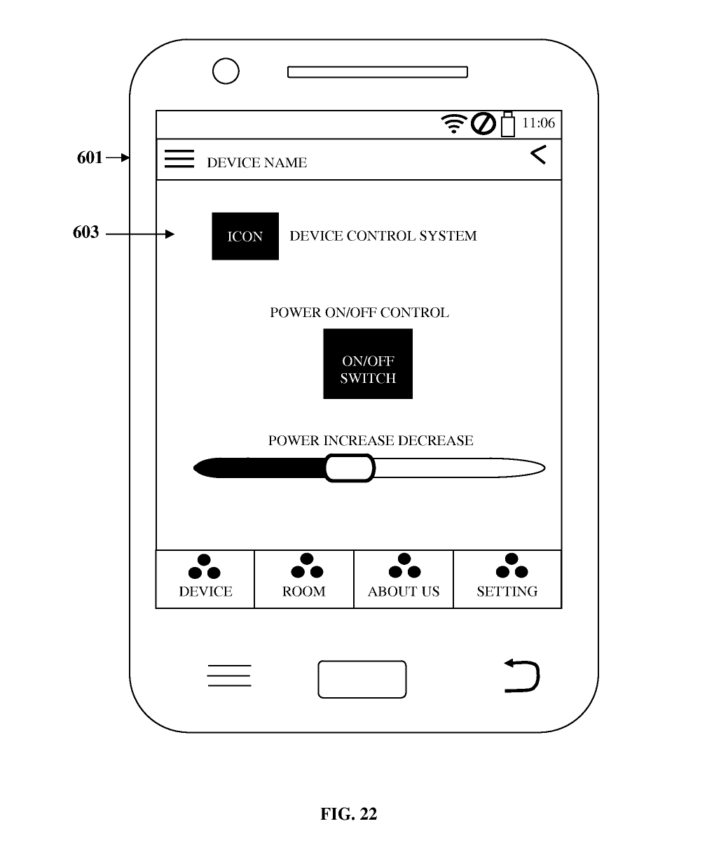

FIG. 22 exemplarily illustrates a screenshot of a power control interface provided on the graphical user interface (GUI) 603 of the appliance management system 602 exemplarily illustrated in FIG. 10. The appliance management application 604 of the appliance management system 602 exemplarily illustrated in FIG. 10, invokes the power control interface when a user clicks an interface element representing a utility appliance in a device menu list displayed on the GUI 603 exemplarily illustrated in FIG. 17. A user can control, for example, activation, deactivation, power intensity, etc., of the utility appliance via the GUI 603. In an embodiment, the appliance management application 604 provides a slider bar interface element on the GUI 603 as exemplarily illustrated in FIG. 22, for receiving user inputs for increasing or decreasing power intensity of a utility appliance.

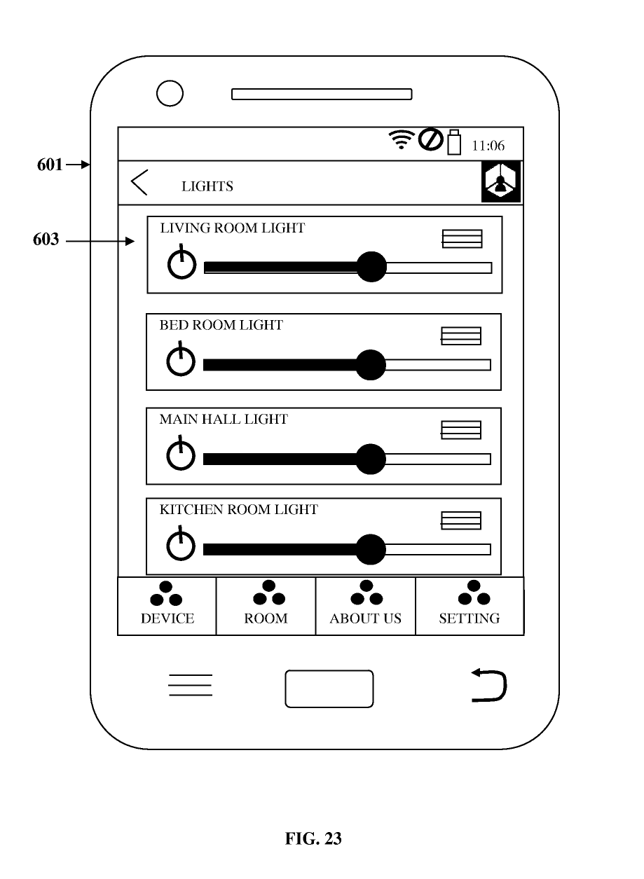

FIG. 23 exemplarily illustrates a screenshot of the graphical user interface (GUI) 603 provided by the appliance management system 602 on a user device 601 exemplarily illustrated in FIG. 10, for remotely managing and controlling lights. As exemplarily illustrated in FIG. 23, a user remotely manages and controls lights positioned in different rooms, for example, a living room, a bed room, a main hall, a kitchen room, etc., via the appliance management application 604 of the appliance management system 602 on the user device 601 exemplarily illustrated in FIG. 10. The GUI 603 displays slider bar interface elements for each of the lights as exemplarily illustrated in FIG. 23, to allow the user to increase or decrease intensity or brightness of the lights.

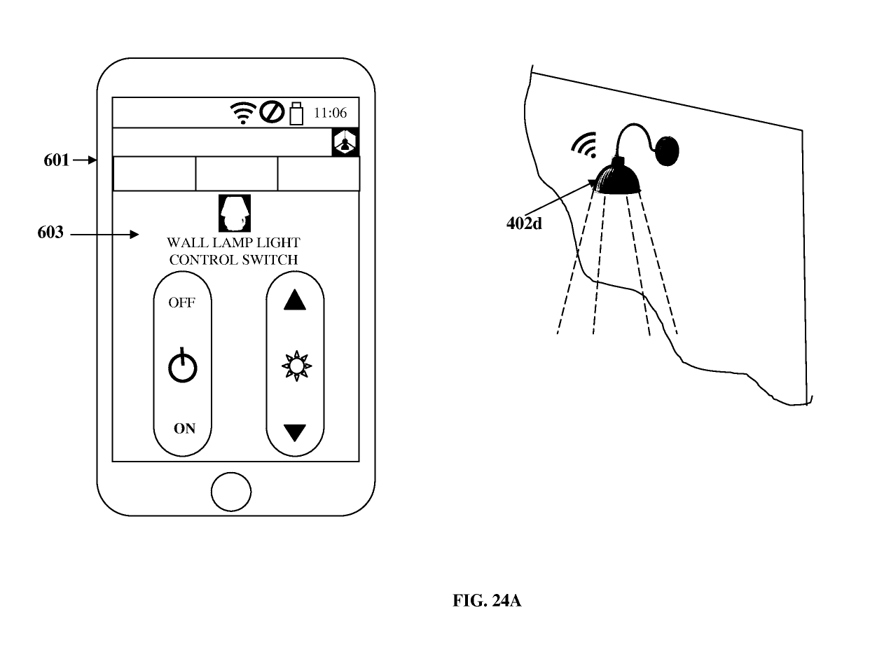

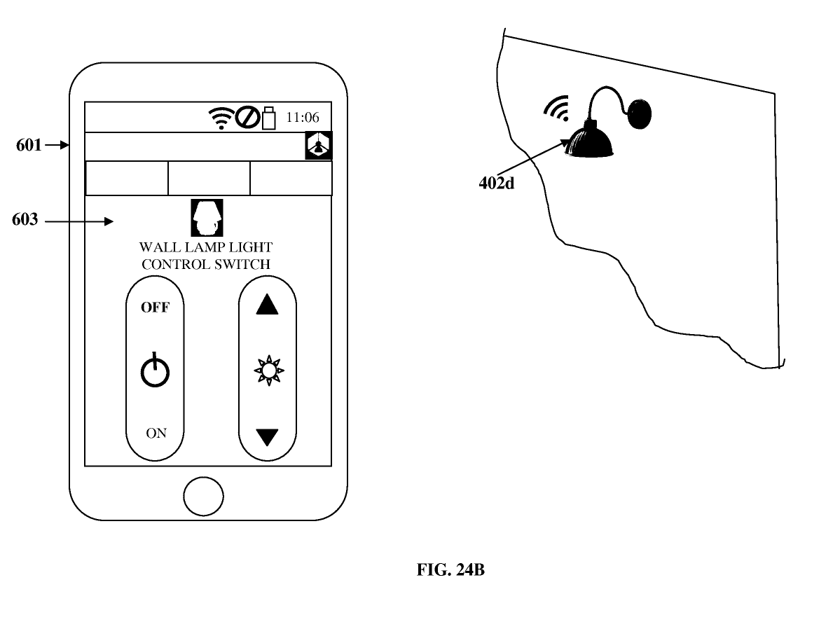

FIGS. 24A-24B exemplarily illustrate screenshots of the graphical user interface (GUI) 603 provided by the appliance management system 602 on a user device 601 exemplarily illustrated in FIG. 10, for remote activation and deactivation of lights. The appliance management system 602 enables the user to remotely manage and control a utility appliance, for example, a wall light 402d when the user is indoors or outdoors. FIG. 24A exemplarily illustrates powering on of the wall light 402d. FIG. 24B exemplarily illustrates powering off of the wall light 402d based on a user input that the appliance management system 602 receives from the user via the GUI 603.

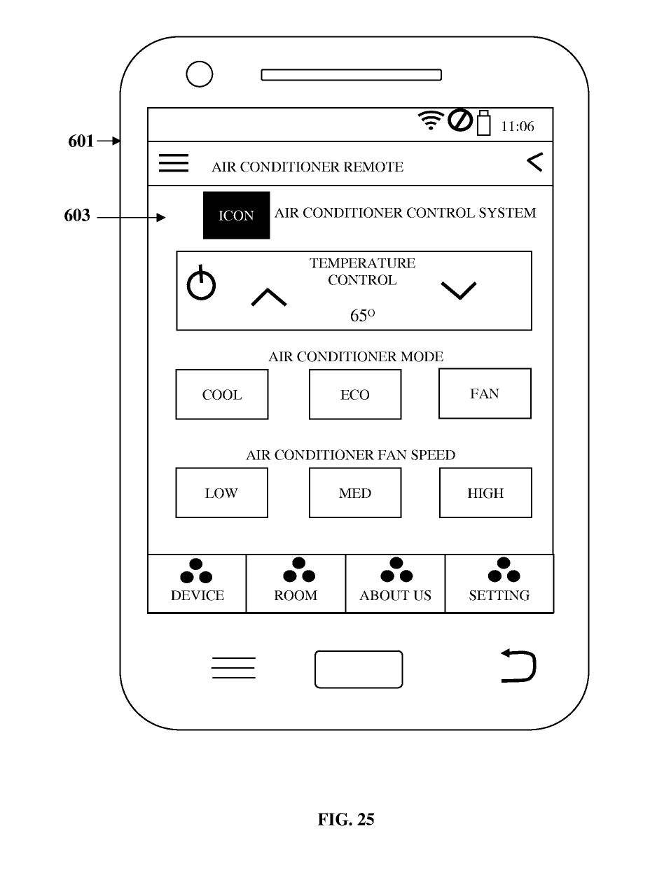

FIG. 25 exemplarily illustrates a screenshot of the graphical user interface (GUI) 603 provided by the appliance management system 602 exemplarily illustrated in FIG. 10, for remotely managing and controlling an air conditioner 402g exemplarily illustrated in FIG. 7. Consider an example where a user downloads the appliance management application 604 of the appliance management system 602 from an App Store or the Google Play™ Store on the user device 601 exemplarily illustrated in FIG. 10, for example, an iOS® device or an Android device. Once the user creates a profile or a user account via the appliance management application 604, the user can add utility appliances 402 exemplarily illustrated in FIG. 4, FIG. 8, and FIG. 10, for example, his/her home appliances to the user's account for remote management and control via the appliance control device 501 exemplarily illustrated in FIG. 10, that operably interacts with the utility appliances 402. The appliance control device 501 interacts with the appliance management system 602 via a local network 701, for example, a Wi-Fi® local network established by the networking device 702 such as a Wi-Fi® router exemplarily illustrated in FIGS. 7-8 and FIG. 10. The microcontroller unit 501b of the appliance control device 501 exemplarily illustrated in FIG. 7 and FIG. 10, in turn interacts with the utility appliances 402 by controlling the alternating current (AC) load on the utility appliances 402 via the load terminal relay unit 502 exemplarily illustrated in FIGS. 7-8 and FIG. 10. For controlling a utility appliance such as an air conditioner 402g, the user accesses the appliance management application 604 on his/her user device 601 and adds the air conditioner 402g in the device addition interface of the GUI 603 exemplarily illustrated in FIG. 16. On adding the air conditioner 402g, the user can remotely control one or more functionalities comprising, for example, a temperature, a fan speed, a cool mode, a dry mode, a power saving mode, etc., of the air conditioner 402g.

Consider an example where a user, before leaving his/her workplace, wants to switch on an air conditioner 402g at the user's residence and manage the temperature of the air conditioner 402g. The user accesses the appliance management application 604 of the appliance management system 602 on his/her user device 601, for example, a mobile device, selects the time at which the air conditioner 402g is to be switched on, and to which the temperature that the air conditioner 402g is to be set via the GUI 603. As exemplarily illustrated in FIG. 25, the user sets the temperature to 65° F. in an economy mode of operation at a high fan speed via the GUI 603. On entering the settings, the user clicks on an activate button on the GUI 603 on his/her user device 601 to switch on the air conditioner 402g. The appliance management application 604 generates and transmits the appliance control data associated with the activation to the appliance control device 501 via the local network 701. The appliance control device 501 generates a control data signal indicating the settings desired by the user and transmits the control data signal to the load terminal relay unit 502 via the local network 701. The load terminal relay unit 502 in turn switches on the air conditioner 402g.

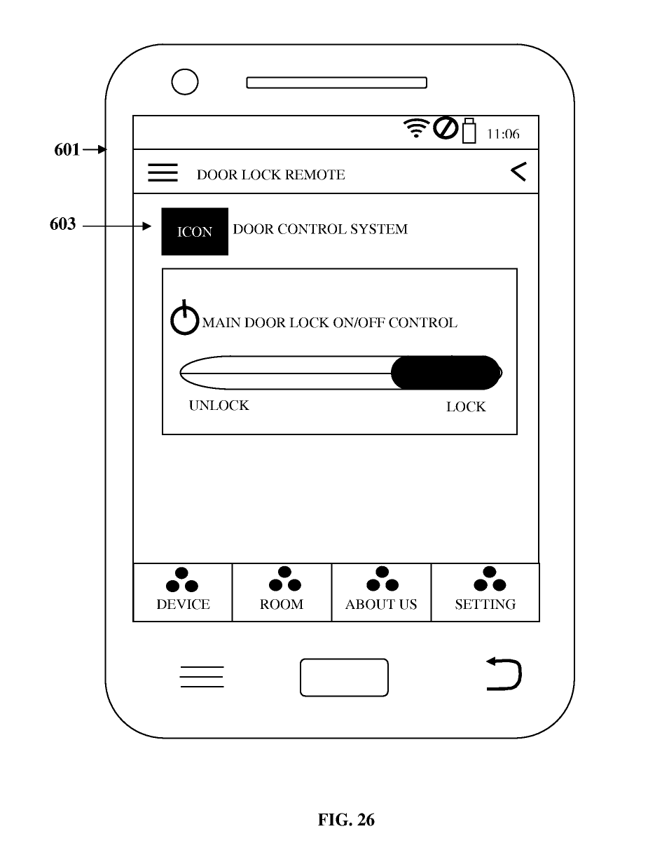

FIG. 26 exemplarily illustrates a screenshot of the graphical user interface (GUI) 603 provided by the appliance management system 602 on a user device 601 exemplarily illustrated in FIG. 10, for remotely managing and controlling an electronic door lock. The appliance control device 501 exemplarily illustrated in FIG. 10, operably communicates with the electronic door lock via the load terminal relay unit 502 exemplarily illustrated in FIG. 10, and controls and manages the electronic door lock via user inputs received from the appliance management system 602. In an embodiment, if a user attempts to access a locked door, the appliance control device 501 triggers an alarm. In another embodiment, the appliance control device 501 transmits the triggered alarm notification to the appliance management system 602 on the user device 601.

Consider an example where a user wants to lock or unlock a main door of his/her office, house, or garage. The user adds a main door as a utility appliance via the GUI 603 of the appliance management system 602 on the use device 601 for controlling the electronic door lock functionality of the main door. The appliance control device 501 communicates with the load terminal relay unit 502 to control the electronic door locks via the local network 701 exemplarily illustrated in FIGS. 7-8 and FIG. 10, for example, an infrared network. The user accesses the appliance management system 602 on the user device 601, logs into the appliance management application 604 of the appliance management system 602 exemplarily illustrated in FIG. 10, and selects the utility appliance to be controlled, that is, the main door. The appliance management application 604 displays multiple electronic main doors that are added via the GUI 603, for example, an office main door, a house main door, or a garage main door. Considering that the user wants to ensure that he/she had locked the main door of his/her house on the way to work, he/she selects the house main door option displayed on the GUI 603 and then clicks on a lock button provided on the GUI 603 as exemplarily illustrated in FIG. 26 to lock the main door. The appliance management system 602 transmits the appliance control data for controlling the main door to the appliance control device 501, which generates and transmits a control data signal indicating the locking action of the main door, to the load terminal relay unit 502 via the local network 701. The load terminal relay unit 502 in turn locks the main door. In an embodiment, a motor is operably connected to the door lock to control the locking of the doors.

FIG. 27 exemplarily illustrates a screenshot of the graphical user interface (GUI) 603 provided by the appliance management system 602 on a user device 601 exemplarily illustrated in FIG. 10, for remotely managing and controlling a television (TV) set 402i exemplarily illustrated in FIG. 9, via an infrared network. Consider an example where a user wants to use his/her user device 601 as a universal remote to control one or more features of the TV set 402i. The features comprise, for example, changing channels, managing volume, etc., as exemplarily illustrated in FIG. 27. The appliance management system 602 interacts with the TV set 402i via the infrared network. For controlling the features of the TV set 402i, the user accesses the appliance management system 602 on the user device 601, logs into the appliance management application 604 of the appliance management system 602 exemplarily illustrated in FIG. 10, and selects the TV set 402i to be controlled. The appliance management application 604 displays multiple features of a television remote control on the GUI 603. For example, if the user wants to change a channel, the user selects a channel menu displayed on the GUI 603 that allows the user to change the channel. On selecting the feature to be controlled, the appliance management application 604 of the appliance management system 602 transmits a control data signal, for example, an infrared signal, to the TV set 402i via the infrared network. In an embodiment, the appliance management application 604 of the appliance management system 602, via the internet, transmits the infrared signal to the appliance control device 501 exemplarily illustrated in FIG. 10, which in turn transmits the infrared signal to the TV set 402i to change the channels. The TV set 402i receives the control data signal from the appliance management application 604 of the appliance management system 602 and changes the channels as desired by the user. The user can perform similar actions for controlling other features of the TV set 402i.

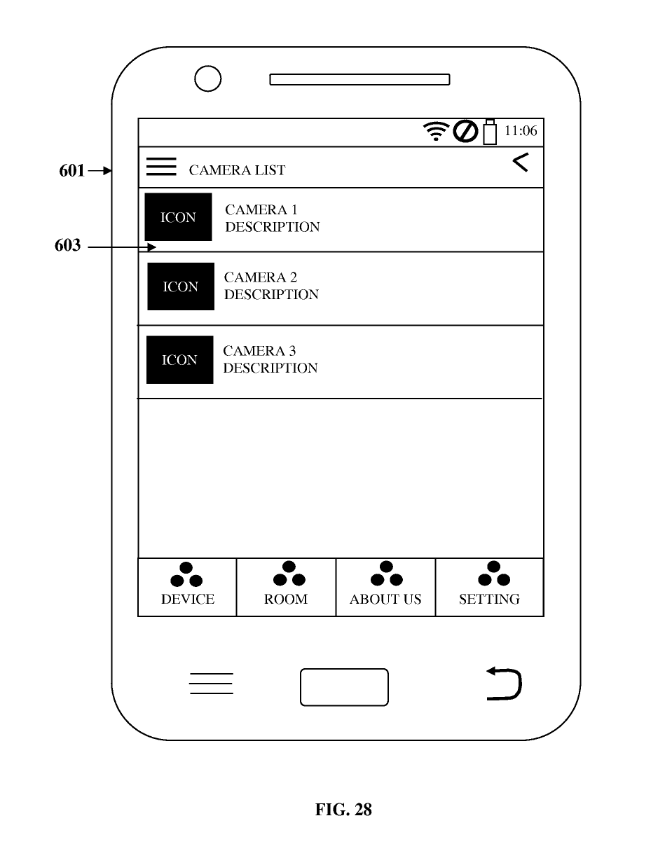

FIG. 28 exemplarily illustrates a screenshot of a camera list interface provided on the graphical user interface (GUI) 603 of the appliance management system 602 exemplarily illustrated in FIG. 10. The camera list interface displays a list of cameras, for example, camera 1, camera 2, camera 3, etc., installed in the user's house along with a description for each camera as exemplarily illustrated in FIG. 28.

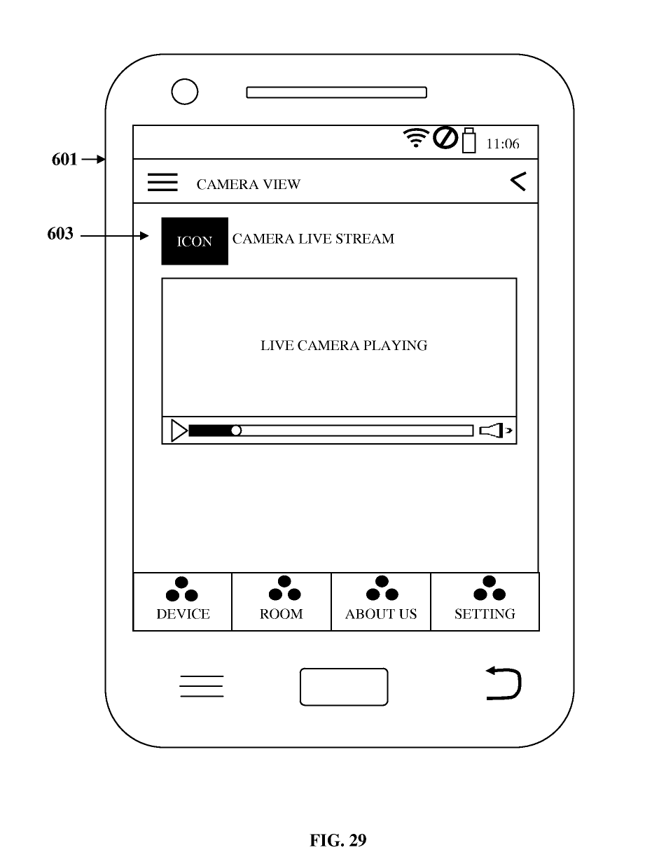

FIG. 29 exemplarily illustrates a screenshot of a video player interface provided on the graphical user interface (GUI) 603 of the appliance management system 602 exemplarily illustrated in FIG. 10. A user can select a camera from the camera list displayed on the GUI 603 exemplarily illustrated in FIG. 28, to activate the camera and view a live stream from the selected camera on the GUI 603 as exemplarily illustrated in FIG. 29.

It will be readily apparent that the various methods, algorithms, and computer programs disclosed herein may be implemented on computer readable media appropriately programmed for computing devices. As used herein, “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Objective-C®, Java®, JavaScript®, Fortran, Ruby, Perl®, Python®, Visual Basic®, hypertext preprocessor (PHP), Microsoft® .NET etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises one or more computer program codes for implementing the processes of various embodiments.

Where databases are described such as the database 1005, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method for remotely managing and controlling one or more of a plurality of utility appliances, said method comprising:
providing an appliance control device configured to operably communicate with an appliance management system accessible on a user device via a local network, said appliance control device further configured to operably communicate with and control said utility appliances via a load terminal relay unit;
communicating an activation status of each of said one or more of said utility appliances to said appliance management system by said appliance control device via said local network;
receiving appliance control data for controlling said one or more of said utility appliances based on said communicated activation status from said appliance management system by said appliance control device via said local network;
processing said received appliance control data by said appliance control device to generate a control data signal configured to indicate one or more actions to be performed by said one or more of said utility appliances; and
transmitting said generated control data signal to said load terminal relay unit by said appliance control device for actuating said one or more of said utility appliances to perform said one or more actions.

2. The method of claim 1, further comprising establishing said local network by a networking device to operably communicate with said appliance control device and said appliance management system accessible on said user device to exchange data, wherein said networking device is configured to check presence of said appliance control device to exchange said data with said appliance control device.

3. The method of claim 1, further comprising communicating a network connection status by said appliance control device to said appliance management system accessible on said user device.

4. The method of claim 1, further comprising generating a confirmation message configured to indicate a current said activation status of said each of said one or more of said utility appliances and transmitting said generated confirmation message to said appliance management system accessible on said user device, by said appliance control device via said local network.

5. The method of claim 1, further comprising dynamically updating and storing said activation status of said each of said one or more of said utility appliances by said appliance control device for enabling said actuation of said one or more of said utility appliances to perform said one or more actions indicated in said generated control data signal on an occurrence of an electric power restoration from a power source.

6. The method of claim 1, further comprising establishing an infrared communication between said appliance management system accessible on said user device and one or more of said appliance control device and said one or more of said utility appliances to allow said appliance management system to remotely manage and control said one or more of said utility appliances.

7. The method of claim 1, wherein said load terminal relay unit is configured to manage and control loading of said one or more of said utility appliances on receiving said generated control data signal from said appliance control device.

8. The method of claim 1, wherein said appliance control data is configured as a string command in a string format, and wherein said appliance control device is further configured to convert said string format of said appliance control data into a serial data format.

9. The method of claim 1, wherein said one or more actions to be performed by said actuation of said one or more of said utility appliances comprise powering said one or more of said utility appliances, powering said one or more of said utility appliances after a predefined time period, deactivating said one or more of said utility appliances, controlling one or more operational parameters associated with said one or more of said utility appliances, and any combination thereof.

10. The method of claim 9, wherein said operational parameters comprise temperature, speed, light intensity, image capture, security, light color, channels of an entertainment one of said utility appliances, volume, and any combination thereof.

11. A computer implemented method for remotely managing and controlling one or more of a plurality of utility appliances, said method employing an appliance management system comprising at least one processor configured to execute computer program instructions for performing said method, said method comprising:
acquiring an activation status of each of said one or more of said utility appliances from an appliance control device by said appliance management system accessible on a user device via a local network, said appliance management system configured to operably communicate with said appliance control device via said local network, said appliance control device configured to operably communicate with and control said utility appliances via a load terminal relay unit;
receiving user inputs to control said one or more of said utility appliances based on said acquired activation status by said appliance management system via a graphical user interface provided by said appliance management system;
generating appliance control data for controlling said one or more of said utility appliances by said appliance management system based on said received user inputs; and
transmitting said generated appliance control data to said appliance control device by said appliance management system via said local network to allow said appliance control device to generate a control data signal by processing said generated appliance control data, said generated control data signal configured to indicate one or more actions to be performed by said one or more of said utility appliances, said generated control data signal further configured to be transmitted to said load terminal relay unit by said appliance control device for actuating said one or more of said utility appliances to perform said one or more actions.

12. The computer implemented method of claim 11, further comprising rendering and activating one or more interface elements associated with said one or more of said utility appliances recognized by said appliance management system on said graphical user interface of said appliance management system based on said acquired activation status of said each of said one or more of said utility appliances.

13. The computer implemented method of claim 11, further comprising facilitating addition of said one or more of said utility appliances to be controlled by said appliance control device via said graphical user interface by said appliance management system accessible on said user device.

14. The computer implemented method of claim 11, further comprising activating said graphical user interface of said appliance management system accessible on said user device based on a network connection status of said appliance control device.

15. The computer implemented method of claim 11, further comprising configuring said appliance control device by said appliance management system accessible on said user device based on supplementary user inputs received from said user device via said graphical user interface of said appliance management system for actuating said one or more of said utility appliances to perform said one or more actions indicated in said generated control data signal.

16. The computer implemented method of claim 11, further comprising receiving a confirmation message configured to indicate a current said activation status of said each of said one or more of said utility appliances from said appliance control device by said appliance management system on said graphical user interface via said local network.

17. The computer implemented method of claim 11, further comprising establishing an infrared communication between said appliance management system accessible on said user device and one or more of said appliance control device and said one or more of said utility appliances to allow said appliance management system to remotely manage and control said one or more of said utility appliances.

18. The computer implemented method of claim 11, further comprising providing an agent server configured to operably communicate with said appliance management system accessible on said user device via a communication network, and with one or more of a plurality of sensors operably connected to said appliance control device via said local network, wherein said agent server is further configured to identify said user device, said appliance control device, and each of said sensors by an identification address.

19. The computer implemented method of claim 18, further comprising receiving alert information from said agent server by said appliance management system accessible on said user device via said communication network, wherein said alert information is transmitted by said one or more of said sensors to said agent server via said communication network.

20. The computer implemented method of claim 18, further comprising:
transmitting an image capture request by said appliance management system accessible on said user device to said appliance control device via said agent server over said communication network, wherein said appliance control device is further configured to generate and transmit a control data signal to an image capture device in operable communication with said appliance control device via said local network for capturing an image based on said image capture request, and wherein said appliance control device is further configured to transmit said captured image to said agent server via said communication network; and
receiving said captured image from said agent server by said appliance management system accessible on said user device via said communication network.

21. A system for remotely managing and controlling one or more of a plurality of utility appliances, said system comprising:
an appliance management system accessible on a user device and configured to operably communicate with an appliance control device via a local network, said appliance management system comprising:
a non-transitory computer readable storage medium configured to store computer program instructions defined by modules of said appliance management system;
at least one processor communicatively coupled to said non-transitory computer readable storage medium, said at least one processor configured to execute said defined computer program instructions;
a first data communication module configured to acquire an activation status of each of said one or more of said utility appliances from said appliance control device via said local network;
said first data communication module further configured to receive user inputs to control said one or more of said utility appliances based on said acquired activation status via a graphical user interface provided by said appliance management system;
a first data processing module configured to generate appliance control data for controlling said one or more of said utility appliances based on said received user inputs; and
said first data communication module further configured to transmit said generated appliance control data to said appliance control device via said local network; and
said appliance control device configured to operably communicate with and control said utility appliances via a load terminal relay unit, said appliance control device comprising a microcontroller unit configured to execute computer program instructions defined by modules of said appliance control device, said modules comprising:
a second data communication module configured to receive said transmitted appliance control data for controlling said one or more of said utility appliances based on said acquired activation status from said appliance management system via said local network;
a second data processing module configured to process said received appliance control data for generating a control data signal configured to indicate one or more actions to be performed by said one or more of said utility appliances; and
said second data communication module further configured to transmit said generated control data signal to said load terminal relay unit for actuating said one or more of said utility appliances to perform said one or more actions.

22. The system of claim 21, further comprising a networking device configured to establish said local network for operably communicating with said appliance control device and said appliance management system accessible on said user device to exchange data, wherein said networking device is further configured to check presence of said appliance control device to exchange said data with said appliance control device.

23. The system of claim 21, wherein said second data communication module of said appliance control device is further configured to communicate a network connection status to said appliance management system accessible on said user device.

24. The system of claim 21, wherein said second data processing module of said appliance control device is further configured to generate a confirmation message configured to indicate a current said activation status of said each of said one or more of said utility appliances, and wherein said second data communication module of said appliance control device is further configured to transmit said generated confirmation message to said appliance management system accessible on said user device via said local network.

25. The system of claim 21, wherein said appliance control device further comprises a non-transitory computer readable storage medium communicatively coupled to said microcontroller unit of said appliance control device, wherein said non-transitory computer readable storage medium is configured to dynamically store said activation status of said each of said one or more of said utility appliances for enabling said actuation of said one or more of said utility appliances to perform said one or more actions indicated in said generated control data signal on an occurrence of an electric power restoration from a power source.

26. The system of claim 21, further comprising an agent server configured to operably communicate with said appliance management system accessible on said user device via a communication network, and with one or more of a plurality of sensors operably connected to said appliance control device via said local network, wherein said agent server is further configured to identify said user device, said appliance control device, and each of said sensors by an identification address.

27. The system of claim 26, wherein said agent server comprises an alert management module configured to transmit alert information to said appliance management system accessible on said user device via said communication network, wherein said alert information is transmitted by said one or more of said sensors to said agent server via said communication network.

28. The system of claim 26, wherein said agent server further comprises an image management module configured to perform:
transmitting an image capture request received from said appliance management system accessible on said user device to said appliance control device over said communication network, wherein said appliance control device is further configured to generate and transmit a control data signal to an image capture device in operable communication with said appliance control device via said local network for capturing an image based on said image capture request;
receiving said captured image from said appliance control device via said communication network; and
transmitting said captured image to said appliance management system accessible on said user device via said communication network.

29. The system of claim 21, wherein said appliance control device further comprises a format converter configured to convert a string format of said appliance control data into a serial data format for transmission to said second data processing module of said appliance control device.

30. The system of claim 21, wherein each of said user device, said appliance control device, and said one or more of said utility appliances comprises inbuilt infrared transceivers configured to establish an infrared communication between said appliance management system accessible on said user device and one or more of said appliance control device and said one or more of said utility appliances to allow said appliance management system to remotely manage and control said one or more of said utility appliances.

31. The system of claim 21, wherein said load terminal relay unit is configured to manage and control loading of said one or more of said utility appliances on receiving said generated control data signal from said second data communication module of said appliance control device.

32. The system of claim 21, wherein said load terminal relay unit comprises one or more relay switches selected from the group consisting of mechanical relay switches, digital relay switches, multi-way relay switches, and combinations thereof.

33. The system of claim 21, wherein said first data processing module of said appliance management system is further configured to render and activate one or more interface elements associated with said one or more of said utility appliances recognized by said appliance management system on said graphical user interface of said appliance management system based on said acquired activation status of said each of said one or more of said utility appliances.

34. The system of claim 21, wherein said graphical user interface of said appliance management system accessible on said user device is further configured to facilitate addition of said one or more of said utility appliances to be controlled by said appliance control device.

35. The system of claim 21, wherein said graphical user interface of said appliance management system accessible on said user device is activated on said user device based on a network connection status of said appliance control device.

36. The system of claim 21, wherein said first data processing module of said appliance management system accessible on said user device is further configured to configure said appliance control device based on supplementary user inputs received from said user device via said graphical user interface of said appliance management system for actuating said one or more of said utility appliances to perform said one or more actions indicated in said generated control data signal.

37. A computer program product comprising a non-transitory computer readable storage medium, said non-transitory computer readable storage medium storing computer program codes that comprise instructions executable by at least one processor, said computer program codes comprising:
a first computer program code for communicating an activation status of each of one or more of a plurality of utility appliances to an appliance management system accessible on a user device via a local network;
a second computer program code for receiving appliance control data for controlling said one or more of said utility appliances based on said communicated activation status from said appliance management system via said local network;
a third computer program code for processing said received appliance control data to generate a control data signal configured to indicate one or more actions to be performed by said one or more of said utility appliances; and
a fourth computer program code for transmitting said generated control data signal to a load terminal relay unit for actuating said one or more of said utility appliances to perform said one or more actions.

38. The computer program product of claim 37, further comprising a fifth computer program code for dynamically updating and storing said activation status of said each of said one or more of said utility appliances for enabling said actuation of said one or more of said utility appliances to perform said one or more actions indicated in said generated control data signal on an occurrence of an electric power restoration from a power source.
